(19) United States
(12) Patent Application Publication
(10) Pub. No.: US 2025/0310867 A1
(43) Pub. Date: Oct. 2, 2025

(54) Methods and Apparatus for Supporting Different Levels of WiFi Service

(71) Applicant: Charter Communications Operating, LLC, St. Louis, MO (US)

(72) Inventor: Marcus Maranhao, Irvine, CA (US)

(21) Appl. No.: 18/617,581

(22) Filed: Mar. 26, 2024

(51) Int. Cl. H04W 48/18; H04W 88/06

(52) U.S. Cl. CPC H04W 48/18; H04W 88/06

(57) ABSTRACT

A communications device, e.g., a residential gateway (RG) or a home router, located at a customer premises which supports cellular and WiFi services, identifies end user communications devices, e.g., cellphones, which support both cellular communications and WiFi communications, via matching, e.g., to within a predetermined time, a detected cellular connection time to a detected WiFi association time. The cellular communications service provider, to which the owner of each identified end user device is a subscriber, is also identified. The communications device, e.g., the RG, provides different levels of WiFi service, to different end user devices, based on the identified communications service provider corresponding to an end user device and any existing WiFi service agreements between service providers.

### FIELD

The present application relates to communications systems and, more particularly, to methods and apparatus related to identifying devices and/or service providers and to providing different levels of WiFi service to different devices at a customer premises.

### BACKGROUND

Modern cellphones normally support WiFi capability in addition to the ability to communicate via a cellular network. Currently, it is not possible for a residential device, which supports WiFi, such as a home router or a residential gateway, to determine if a particular WiFi device, connecting to the residential device, is part of a cellphone.

A number of communications service providers, e.g., cell phone operators, are in the process of offering mobile services using Citizens Broadband Radio Service (CBRS) via a frequency band referred to as a CBRS band, either as part of a priority access license (PAL) service tier, or as part of the general authorized access (GAA) service tier, this last tier being available to anyone, without the need of any license at all.

It is possible that an individual has broadband services (Internet) at their residence or business location, sometimes referred to as a customer premises, with one service provider, e.g., service provider A, while having mobile communications services, e.g., cellular services, from one or more other service providers, e.g. a cellular service provider B. Thus, a first service provider who supplies services to a first customer premises may be different from a second service provider, used to provide cellular services to cellular devices of the customer premises owner and/or visitors to the customer premises.

From a service provider perspective, it is desirable to provide different levels, e.g., tiers, of service to different users based on contractual obligations and/or for other reasons.

Let us assume a scenario where a particular household gets its broadband service from service provider A. In this case when an individual who subscribes to mobile service from service provider B comes to the home with a cellphone (and let us assume that this cellphone operates in the CBRS band), the individual can use the WiFi from the phone to browse the Internet, and the traffic from the WiFi of the cellphone will be consuming bandwidth of the broadband service of provider A.

The concept of wireless equality as defined by some, is that the traffic of a WiFi device that is part of a cellphone which is serviced by service provider B, which is different from service provider A should: a) be given a lesser QoS than the service provided to the subscribers of service provider A, or b) have service provider B somehow compensate service provider A, for the service of carrying traffic from service provider B in the network of service provider A. Based on the above discussion, there is a need for new methods and apparatus to be able to identify if a WiFi device, connected to the customer premises, e.g., home, WiFi access point (AP) is part of a cellphone and to be able to identify which service provider that cellphone is subscribed to. There is a feature referred to as medium media access control (MAC) randomization, which allows a WiFi device to hide the exact identity of the WiFi device (original MAC address sometimes referred to as hardware MAC address), by generating and using a randomized MAC address (artificial temporary MAC address), for each new attachment. The MAC randomization feature, when implemented, complicates the problem of identifying if a WiFi device as being part of a cellphone and identifying the service provider of the cellphone, as the same WiFi device may use a different randomized MAC address each time it attaches to the same WiFi access point at the customer premises. Based on the above discussion, it would be advantageous if at least some of these new methods and apparatus could be developed for identifying when a WiFi device corresponds to a cell phone and identifying the service provider of the cell phone.

While not necessary for all implementations, it would be desirable if the methods and/or apparatus could work even in the case of MAC randomization, by a cellphone supporting WiFi, and facilitate cellular service provider identification even in the case where of the original MAC address is hidden from the network providing WiFi service.

### SUMMARY

Methods and apparatus, in accordance with the present invention, are directed to identifying, at a communications device such as a gateway, e.g., a residential gateway (RG), or a router, located at a customer premises, an end user device, which supports both cellular and WiFi communications. Such an end user may be a cellphone supporting cellular communications and WiFi communications. In addition to identifying an end user device with both WiFi and cellular capability, various features relate to determining the communications service provider, e.g., mobile network operator (MNO) or mobile virtual network operator (MVNO), to which the owner of the identified end user device subscribes for cellular communications service. The communications device, e.g. the RG, decides the level of WiFi service to be provided to the identified end user device, based on: i) whether or not the communications service provider, to which the owner of the identified end user device subscribes to for cellular communications service, is the same or is different than the communications service provider corresponding to the communications device, e.g. RG located at the customer premises, and/or ii) whether or not there is a WiFi service agreement between: (a) the communications service provider, to which the owner of the identified end user device subscribes to for cellular communications service, and (b) the communications service provider corresponding to the communications device, e.g. RG located at the customer premises. The WiFi service agreement between communications service providers may be a stand-alone agreement between service providers or part of another service agreement between service providers, e.g., an overall service agreement which includes a cellular service agreement between the providers to which the agreement relates and a WiFi service agreement between providers to which the agreement relates. In some cases a cellular service agreement may exist between service providers allowing a cell phone to connect to a base station and obtain cellular service but there may not be a corresponding WiFi service agreement. In some embodiments, a residential gateway (RG), a cellular base station, e.g., a femtocell HgNB Citizens Broadband Radio Services (CBRS) base station, and a WiFi access point (AP) are located at the customer premises. In some embodiments, the base station and the WiFi AP are included as part of the RG. In other embodiments, one or both of the base station and the WiFi AP are separate entities from the RG but are coupled to the RG and interact with the RG.

The cellular base station monitors for, detects, and reports new cellular connections with end user devices. The reported information includes a cellular connection time for a detected cellular connection along with UE ID information. The reported information is stored. The communications service provider of the end user device, corresponding to the new cellular connection, is determined from information included in the connection establishment signaling. The WiFi AP monitors for, detects, and reports new WiFi connections with end user devices. The information reported by the WiFi AP includes a WiFi association time for a detected WiFi association along with a detected MAC ID (e.g., an original MAC ID for the end user device or a randomized temporary artificial MAC ID) currently being used by the end user device. The information reported by the WiFi AP is also stored and available to be correlated with the cellular information.

For each detected new cellular connection, the communications device, e.g. the RG, checks to determine if there is a corresponding new WiFi association, e.g., which occurred within a predetermined time window. If there is a new WiFi association which was determined to occur within the predetermined time window with respect to the detected new cellular connection, then the communications device, e.g., RG, determines (e.g., infers) that the same device (e.g., a particular cellphone supporting cellular and WiFi communications) corresponds to both the new cellular connection and the new WiFi connection, and the service provider of that device (cellphone) is obtained from the cellphone connection information previously obtained.

The communications device, e.g., RG, is operated to provide a level of WiFi service to each identified end user device, which supports both cellular and WiFi communications, based on the end user device's service provider network and any existing WiFi service agreements between the end user device's service provider and the service provider providing WiFi service for the customer premises. In this way, the communications device, e.g., RG, can provide different levels of WiFi service to different end user devices at the customer premises.

While various features are discussed in the above summary, all features discussed above need not be supported in all embodiments and numerous variations are possible. Additional features, details and embodiments are discussed in the detailed description which follows.

### BRIEF DESCRIPTION OF THE FIGURES

FIG. 1 is a drawing of an exemplary communications system in accordance with an exemplary embodiment.

FIG. 2A is a first part of a flowchart of an exemplary communications method in accordance with an exemplary embodiment.

FIG. 2B is a second part of a flowchart of an exemplary communications method in accordance with an exemplary embodiment.

FIG. 2 comprises the combination of FIG. 2A and FIG. 2B.

FIG. 3A is a first part of a flowchart of an exemplary communications method in accordance with an exemplary embodiment.

FIG. 3B is a second part of a flowchart of an exemplary communications method in accordance with an exemplary embodiment.

FIG. 3C is a third part of a flowchart of an exemplary communications method in accordance with an exemplary embodiment.

FIG. 3D is a fourth part of a flowchart of an exemplary communications method in accordance with an exemplary embodiment.

FIG. 3 comprises the combination of FIG. 3A, FIG. 3B, FIG. 3C and FIG. 3D.

FIG. 4 is a drawing of an exemplary WiFi information table on a WiFi AP of an exemplary residential gateway (RG) in accordance with an exemplary embodiment.

FIG. 5 is a drawing of an exemplary UE (user equipment) information table on a femtocell HgNB CBRS base station of an exemplary residential gateway (RG) in accordance with an exemplary embodiment.

FIG. 6 is a drawing of an exemplary MAC ID-cellphone correlation information table of an exemplary residential gateway (RG) in accordance with an exemplary embodiment.

FIG. 7 is a drawing of an exemplary service provider to WiFi service level mapping information table in accordance with an exemplary embodiment.

FIG. 8 is a drawing of an exemplary WiFi service level mapping table in accordance with an exemplary embodiment.

FIG. 9 is a drawing of another exemplary WiFi service level mapping table in accordance with an exemplary embodiment.

FIG. 10 is a drawing of yet another exemplary WiFi service level mapping table in accordance with an exemplary embodiment.

FIG. 11 is a drawing of an exemplary end user device including cellular and WiFi capabilities, e.g., a cellphone supporting cellular and WiFi communications, in accordance with an exemplary embodiment.

FIG. 12 is a drawing of an exemplary end user device including WiFi capabilities, e.g., a laptop supporting WiFi communications, a desktop PC supporting WiFi communications, a TV supporting WiFi communications, a gaming device supporting WiFi communications, etc., in accordance with an exemplary embodiment.

FIG. 13 is a drawing of an exemplary gateway/router device, e.g., a residential gateway (RG), e.g., a 5G-RG, in accordance with an exemplary embodiment.

FIG. 14 is a drawing of an exemplary base station, e.g., a HgNB CBRS femtocell base station, in accordance with an exemplary embodiment.

FIG. 15 is a drawing of an exemplary WiFi access point (AP), in accordance with an exemplary embodiment.

### DETAILED DESCRIPTION

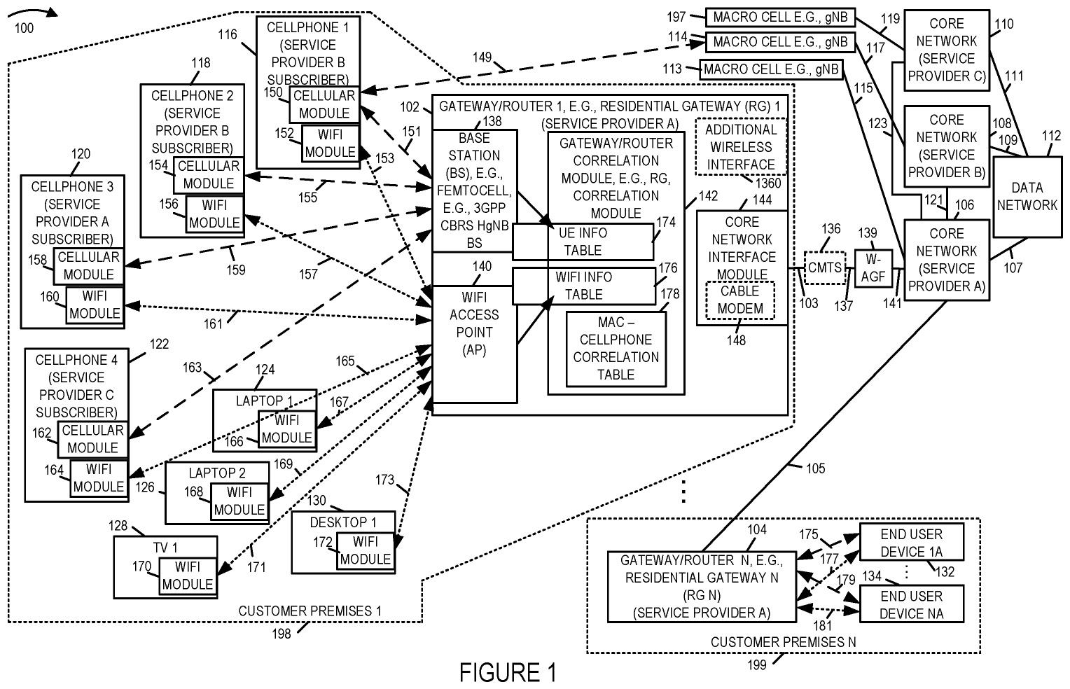

FIG. 1 is a drawing of an exemplary communications system 100 in accordance with an exemplary embodiment. Exemplary communications system 100 includes a plurality of gateways/routers (gateway/router 1 102, . . . , gateway/router N 104), a plurality of macro cells including macro cell 113, e.g., a gNB base station (BS), macro cell 114, e.g., a gNB BS, and macro cell 197, e.g., a gNB BS, a plurality of core networks including service provider A core network 106, service provider B core network 108 and service provider C core network 110 and a data network (DN) 112 coupled together as shown. The core networks (106, 108, 110) are, e.g., mobile network operator (MNO) or virtual mobile network operator (MVNO) core networks. The exemplary communications system 100 further includes a plurality of end user devices supporting wireless communications including cellphone 1 116, cellphone 2 118, cellphone 3 120, cellphone 4 122, laptop 1 124, laptop 2 126, TV 1 128, desktop 1 130, end user device 1A 132 and end user device NA 134.

Gateway/router 1 102, e.g., residential gateway (RG) 1 102, corresponds to service provider A and is coupled to service provider A core network 106 Gateway/router 1 102 includes a base station 138, e.g. a femtocell, e.g., a Citizens Broadband Radio Services (CBRS) HgNB base station, a WiFi access point (AP) 140, a gateway/router correlation module 142, e.g., a RG correlation module, and a core network interface module 144. In some embodiments, the core network interface module 144 include a cable modem (CM) 148, which couples gateway router 1 102 to service provider A core network 106 via communications link 103, cable modem termination system (CMTS) 136, and communications link 137, wireline-access gateway function (W-AGF) 139 and communications link 141. Base station 138, e.g., a femtocell, generates a UE information table 174 based on detected cellular connections with cellular capable end user devices, said UE information table 174 including UE id information and cellular connection time information. WiFi AP 140 generates a WiFi information table 176 based on detected WiFi associations with WiFi capable end user devices, said WiFi information table 176 including MAC ID information and WiFi attachment time information. Gateway/router correlation module 142 correlates, e.g., matches, cellular capable end user devices with WiFi capable end user devices based on cellular connection times/WiFi association times included in the UE information table 174 and WiFi information table 176, e.g., which are within a predetermined time window, indicating that a cellular capable end user device and WiFi capable end user device are the same device, e.g., are a particular cellphone. Gateway/router correlation module 142 generates a MAC-cellphone correlation table 178, which is used in determining a level of WiFi service to provide a visiting cellphone including WiFi capability.

FIG. 1 shows an exemplary embodiment, in which base station 138 and WiFi access point (AP) 140 are included within gateway/router 1 102. In some embodiments, the base station 138 and/or the WiFi AP 140 are distinct entities located outside the gateway/router 1 102. In some embodiments, the base station 138 is located at customer premise 1 198, is located outside of gateway/router 102, and is coupled to gateway/router 102. In some embodiments, the WiFi AP 140 is located at customer premises 1 198, is outside gateway/router 1 138, and is coupled to gateway/router 102.

Cellphone 1 116, which is a cellphone of a subscriber of service provider B, includes cellular module 150 and WiFi module 152. Cellphone 2 118, which is a cellphone of a subscriber of service provider B, includes cellular module 154 and WiFi module 156. Cellphone 3 120, which is a cellphone of a subscriber of service provider A, includes cellular module 158 and WiFi module 160. Cellphone 4 122, which is a cellphone of a subscriber of service provider C, includes cellular module 162 and WiFi module 164. Laptop 1 124 includes a WiFi module 166, Laptop 2 126 includes WiFi module 168, TV1 128 includes WiFi module 170. Desktop 1 130 includes WiFi module 172. End user device 1A 132 is, e.g., a cellphone including a cellular module and a WiFi module or an end user device including a WiFi module without including a cellular module. End user device NA 134 is, e.g., a cellphone including a cellular module and a WiFi module or an end user device including a WiFi module without including a cellular module.

Gateway/router 1 102, e.g., RG 1, is located at customer premises 1 198. Gateway/router N 104, e.g. RG N, is located at customers premises N 199. At different times different sets of end user devices may be located at different customer premises. FIG. 1 shows an example in which cellphone 1 116, cellphone 2 118, cellphone 3 120, cellphone 4 122, laptop 1 124, laptop 2 126, TV 1 128, and desktop 1 130 are located at customer premises 1 198, while end user device 1A 132 and end user device NA 134 are located at customer premises N 199.

Cellular module 150 of cellphone 1 116 may be, and sometimes is, coupled to macro cell base station 114, e.g., a gNB, via cellular wireless communications link 149. Cellular module 150 of cellphone 1 116 may be, and sometimes is, coupled to base station 1 138, e.g., a 3GPP CBRS HgNB femtocell base station, via cellular wireless communications link 151. There may be, and sometimes is, a handoff of cellphone 1 116 from macro cell base station 114 to femtocell base station 138, e.g., as cellphone 1 116 moves from a region outside customer premises 1 198 to a region within customer premises 1 198. WiFi module 152 of cellphone 1 116 is coupled to WiFi AP 140 of gateway/router 1 102, via WiFi wireless communications link 153. Cellular module 154 of cellphone 2 118 is coupled to base station 1 138, e.g., a 3GPP CBRS HgNB femtocell base station, via cellular wireless communications link 155. WiFi module 156 of cellphone 2 118 is coupled to WiFi AP 140 via WiFi wireless communications link 157. Cellular module 158 of cellphone 3 120 is coupled to base station 1 138, e.g., a 3GPP CBRS HgNB femtocell base station, via cellular wireless communications link 159. WiFi module 160 of cellphone 3 120 is coupled to WiFi AP 140 via WiFi wireless communications link 161. Cellular module 162 of cellphone 4 122 may be, and sometimes is, coupled to macro cell base station 197, e.g., a gNB, via a cellular wireless communications link. Cellular module 162 of cellphone 4 122 is coupled to base station 1 138, e.g., a 3GPP CBRS HgNB femtocell base station, via cellular wireless communications link 163. WiFi module 164 of cellphone 4 122 is coupled to WiFi AP 140 via WiFi wireless communications link 165. WiFi module 166 of laptop 1 124 is coupled to WiFi AP 140 via WiFi wireless communications link 167. WiFi module 166 of laptop 1 124 is coupled to WiFi AP 140 via WiFi wireless communications link 167. WiFi module 168 of laptop 2 126 is coupled to WiFi AP 140 via WiFi wireless communications link 169. WiFi module 170 of TV 1 170 is coupled to WiFi AP 140 via WiFi wireless communications link 171. WiFi module 172 of desktop PC 1 130 is coupled to WiFi AP 140 via WiFi wireless communications link 173.

End user device 1A 132 includes a cellular module and/or a WiFi module. If end user device 1A 132 includes a cellular module, end user device 1A 132 may be, and sometimes is, coupled to gateway router N 104, e.g., RG N, via cellular wireless communications link 175. If end user device 1A 132 includes a WiFi module, end user device 1A 132 may be, and sometimes is, coupled to gateway router N 104, e.g., RG N, via WiFi wireless communications link 177. End user device NA 134 includes a cellular module and/or a WiFi module. If end user device NA 134 includes a cellular module, end user device NA 134 may be, and sometimes is, coupled to gateway router N 104, e.g., RG N, via cellular wireless communications link 179. If end user device NA 134 includes a WiFi module, end user device NA 134 may be, and sometimes is, coupled to gateway router N 104, e.g., RG N, via WiFi wireless communications link 181.

Macro cell base station 114, e.g., a gNB, is coupled to service provider B core network 108 via communications link 117. Macro cell base station 113, e.g., a gNB, is coupled to service provider A core network 106 via communications link 115. Macro cell base station 197, e.g. a gNB, is coupled to service provider C core network 110 via communications link 119. Service provider core network A 106 is coupled to service provider core network B 108 via communications link 121. Service provider core network A 106 is coupled to service provider core network C 110 via communications link 123. Service provider core network A 106 is coupled to data network (DN) 112 via communications link 107. Service provider core network B 108 is coupled to data network (DN) 112 via communications link 109. Service provider core network C 110 is coupled to data network (DN) 112 via communications link 111.

In some embodiments, service provider A has a service agreement with service provider B, with regard to providing a level(s) of WiFi wireless service to subscribers of service provider B when end user devices of subscribers of service provider B are located at the customer premises of service provider A, e.g., customer premises 1 198 and customer premises N 199. In some such embodiments, service provider A does not have a service agreement with service provider C, with regard to providing a level(s) of WiFi wireless service to subscribers of service provider C when end user devices of subscribers of service provider C are located at the customer premises of service provider A, e.g., customer premises 1 198 and customer premises N 199.

For example, in some embodiments, cellphone 1 116 and cellphone 2 118, following identification as subscriber B devices are provided a level of WiFi service equal to or greater than the level of WiFi service provided to cellphone 3 120; and cellphone 4 122 is provided a level of WiFi service which is lower than the level of WiFi service provided to cellphone 3 120.

In some embodiments, gateway/router 1 102, e.g., RG 1, includes additional wireless interface 1360, e.g., a 3GPP wireless interface which allows the gateway/router 1 102 to be coupled to core 106, via a radio access network (RAN), e.g., macro cell base station 113, e.g. a gNB. This additional wireless interface 1360 can be used in place of or in addition to core network interface module 144 including wireline interfacing capability including cable modem 148 which is coupled to CMTS 136.

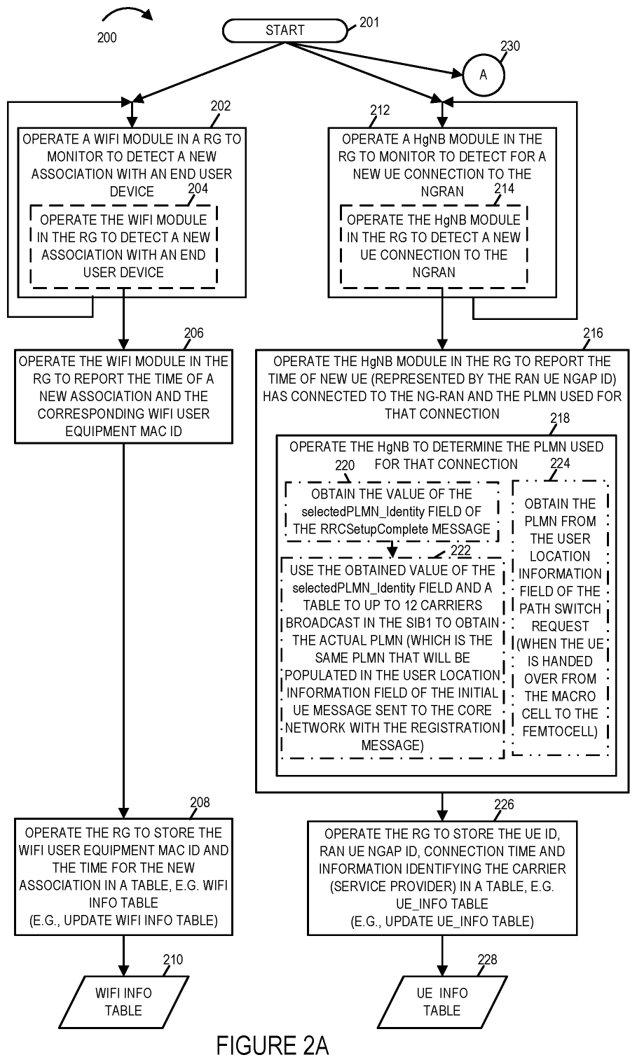

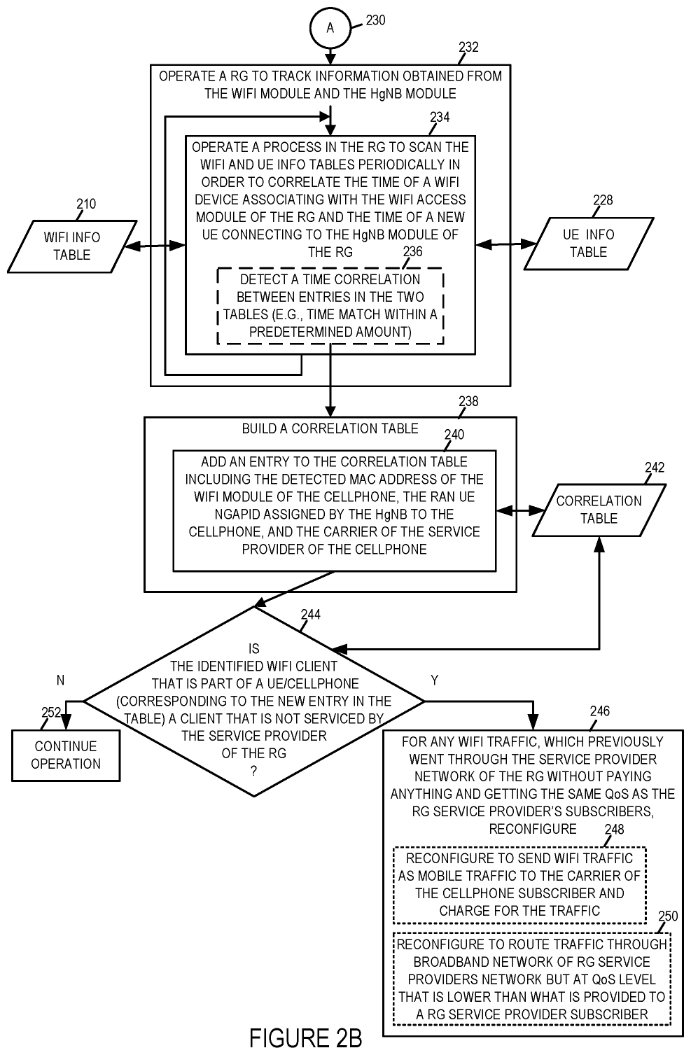

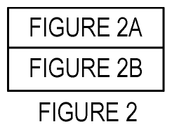

FIG. 2, comprising the combination of FIG. 2A and FIG. 2B, is a flowchart 200 of an exemplary communications method in accordance with an exemplary embodiment. The exemplary communications method of FIG. 2 may be, and sometimes is, performed by elements of communications system 100 of FIG. 1. In step 202 the communications system is powered on and initialized. Operation proceeds from start step 201 to step 202 and step 212, which may be performed in parallel.

In step 202 a WiFi module, e.g., WiFi AP 140, in a residential gateway (RG), e.g., RG 1 102, is operated to monitor to detect a new association with an end user device. The end user device is, e.g., any of: cellphone 1 116, cellphone 2 118, cellphone 3 120, cellphone 4 1222, laptop 1 124, laptop 2 126, TV 1 128 or desktop 1 130. Step 202 is performed repetitively, on an ongoing basis. Step 202 may, and sometimes does includes step 204, in which the WiFi module in the RG detects a new association with an end user device. Operation proceeds from step 204 to step 206.

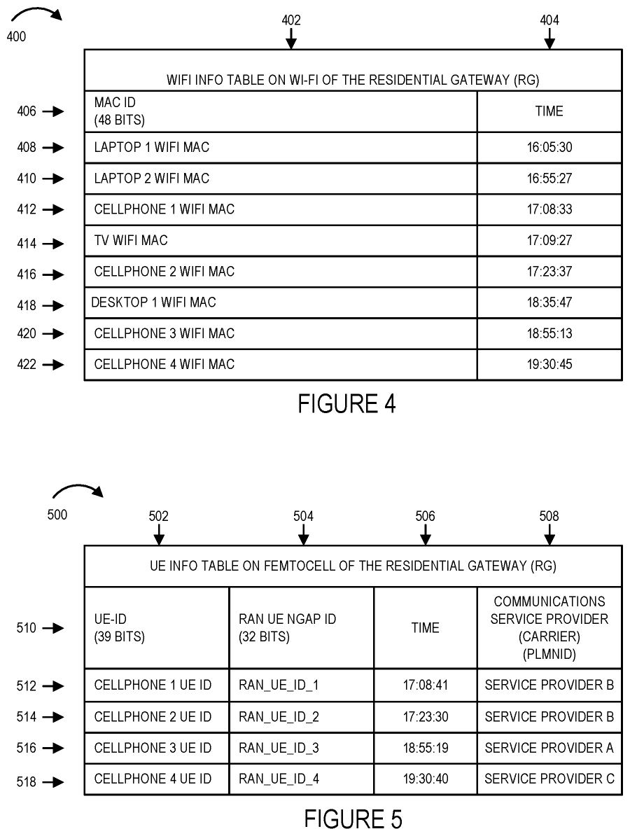

In step 206 the WiFi module in the RG reports the time of a new association and the corresponding WiFi user equipment MAC ID. Operation proceeds from step 206 to step 208. In step 208 the RG stores the WiFi user equipment MAC ID and the time for the new association in a table, e.g., WiFi information table 210. Each iteration of step 208 is an update to the WiFi information table 210. Drawing 400 of FIG. 4 is an example of WiFi information table 210 after a set of WiFi capable end user devices has attached to the WiFi AP.

In step 212 a HgNB module, e.g., base station 138, in the residential gateway (RG), e.g., RG 1 102, is operated to monitor to detect for a new UE connection to the NGRAN. The detected new UE connection corresponds to any of: cellphone 1 116, cellphone 2 118, cellphone 3 120 or cellphone 4 122. Step 212 is performed repetitively, on an ongoing basis. Step 212 may, and sometimes does includes step 214, in which the HgNB module in the RG detects a new UE connection to the NGRAN. Operation proceeds from step 214 to step 216.

In step 216 the HgNB module in the RG reports the time a new UE (represented by the RAN UE NGAP ID) has connected to the NG-RAN and the PLMN used for that connection. Step 216 includes step 218, in which the HgNB in the RG determines the PLMN used for that connection. If the connection is a new connection without handover, then steps 220 and 222 are performed, to obtain the PLMN. However, if the connection is the result of a handover (e.g., a handover from macro cell 114 to femtocell BS 138), then step 224 is performed to obtain the PLMN.

In step 220 the HgNB module obtains the value of the selectedPLMN_Identity field of the RRCSetupComplete message. Operation proceeds from step 220 to step 222. In step 222 the HgNB module uses the obtained value of the selectedPLMN_Identity field of the RRCSetupComplete message and a table of up to 12 carriers broadcast in the SIB1 to obtain the actual PLMN (which is the same PLMN that will be populated in the user location information field of the initial UE message sent to core network with the registration message.)

In step 224, the HgNB module obtained the PLMN from the user location information field of the path switch request message, e.g., when the UE is handed over from the macro cell to the femtocell.

Operation proceeds from step 216 to step 226. In step 226 the RG stores UE ID, RAN UE NGAP ID, connection time and information identifying the carrier (service provider) in a table, e.g., UE information table 228. Each iteration of step 226 is an update to the UE information table 228. Drawing 500 of FIG. 5 is an example of UE information table 228 after a set of cellular capable end user devices have connected to the femtocell base station 138.

Operation also proceeds from start step 201, via connecting node A 230 to step 232 of FIG. 2B. In step 232 the RG is operated to track information obtained from the WiFi modules and HgNB module. Step 232 includes step 234, which is performed repetitively on an ongoing basis. In step 234 a process in the RG is operated to scan the WiFi and UE information tables 210, 228 periodically in order to correlate the time of a WiFi device associating with WiFi access module of the RG and the time of a new UE connecting to the HgNB module of the RG. Step 234 may, and sometimes does, includes step 236. In step 236 the process in the RG detects a time correlation between entries in the two tables, e.g., a time match within a predetermined amount. In response to the detection of the time correlation of step 236, operation proceeds from step 236 to step 238.

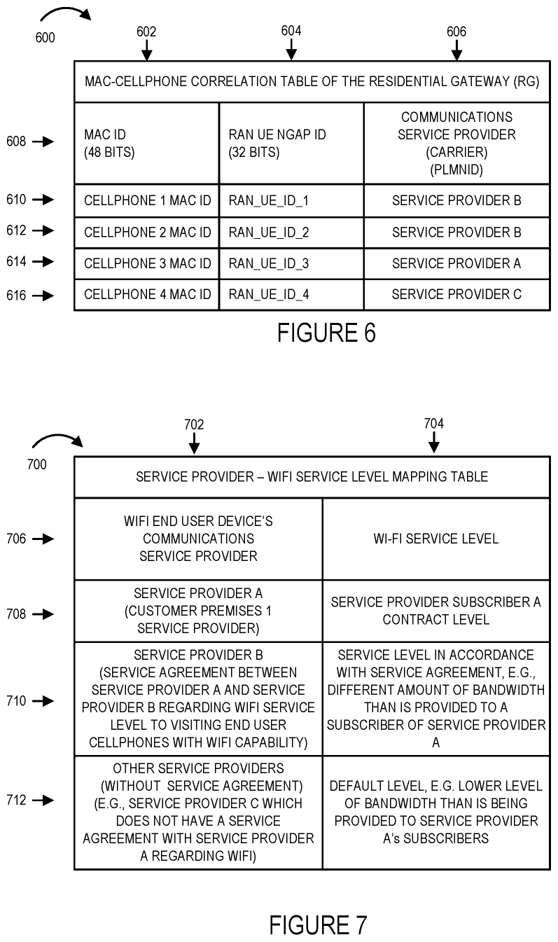

In step 238 the RG is operated to build a correlation table 242. MAC-cellphone correlation table 600 of FIG. 6 is an example of correlation table 242. Step 238 includes step 240, in which the RG add as an entry in the correlation table including the detected MAC address of the WiFi module of the cellphone, the RAN UE NGAPID assigned by the HgNB to the cellphone, and the carrier of the service provider of the cellphone. Operation proceeds from step 240 to step 244.

In step 244 the RG checks as to whether the identified WiFi client that is part of UE/cellphone (corresponding to the new entry in the correlation table) is a client that is not serviced by the service provider of the RG. If the determination is that UE/cellphone is a client being serviced by the service provider of the RG (e.g., the UE/cellphone belongs to a subscriber of the service provider of the RG), then operation proceeds from step 244 to step 252, in which operation continues, e.g., and the UE/cellphone is controlled to receive a level of WiFi service in accordance with the service agreement for the customers of the service provider of the RG. However, if the determination is that UE/cellphone is not a client being serviced by the service provider of the RG (e.g., the UE/cellphone belongs to a subscriber of different service provider than the service provider of the RG), then operation proceeds from step 244 to step 246. In step 246, the RG is operated to reconfigure for any WiFi traffic, which previously went through the service provider of the RG without paying anything and getting the same QoS as the RG service provider's subscribers in accordance with step 248 or step 250. In step 248 the RG reconfigures to send WiFi traffic as mobile traffic to the carrier of the cellphone subscriber and charge for the traffic, e.g., in accordance with a service agreement between the service provider of the RG and the service provider the UE/cellphone. In step 250 the RG configures to route WiFi traffic through the broadband network of the RG service providers network but at a QoS level that is lower than what is provided to a RG service provider subscriber.

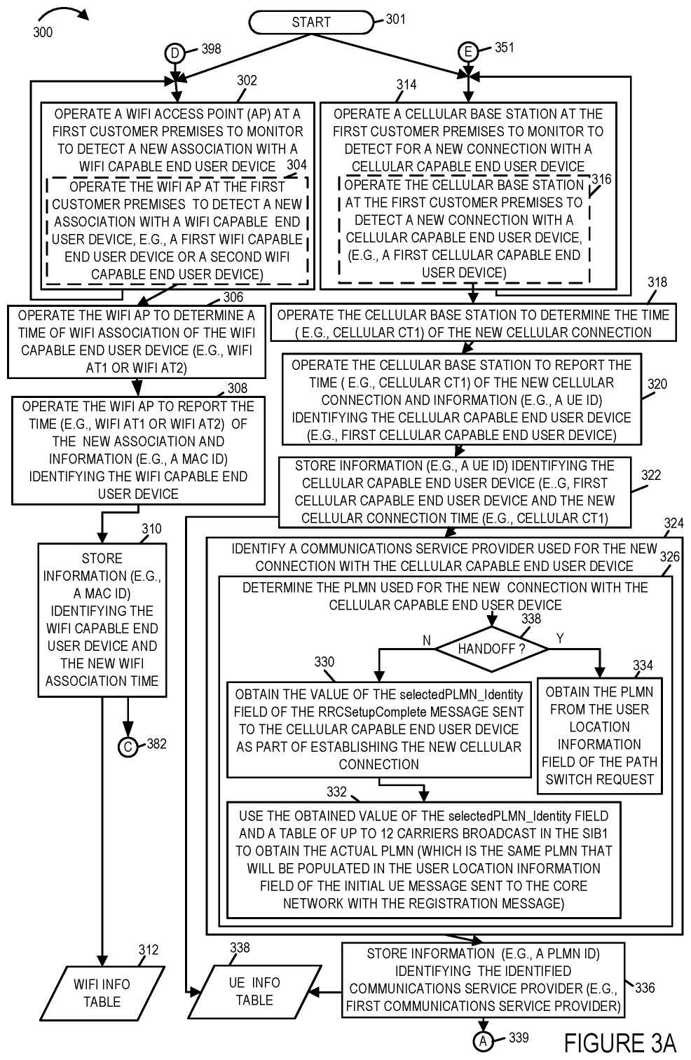

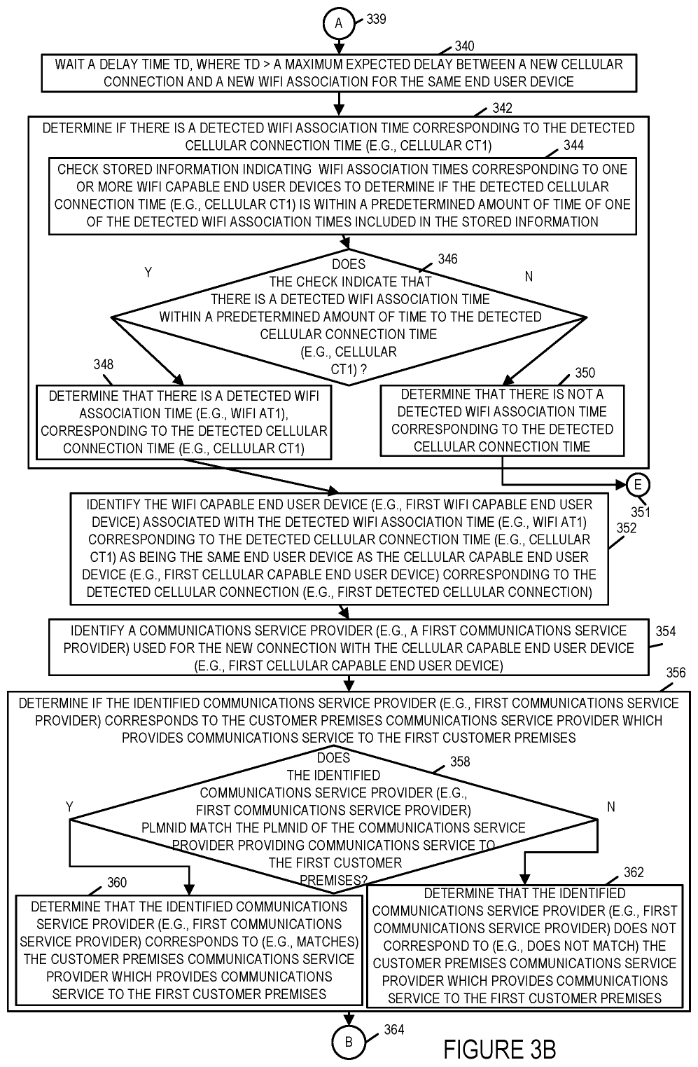

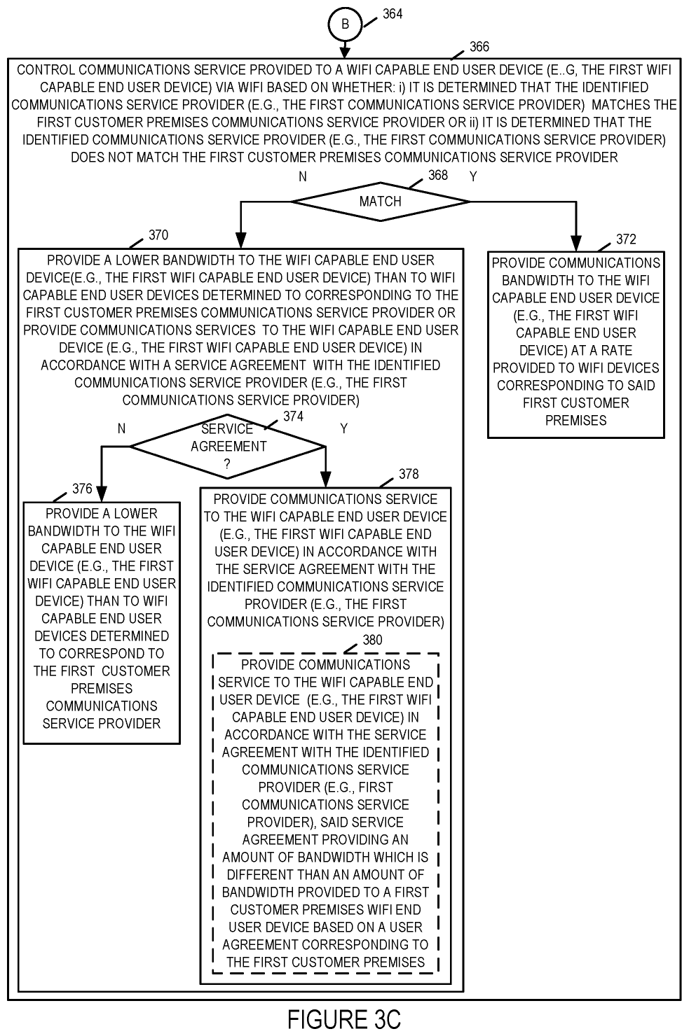

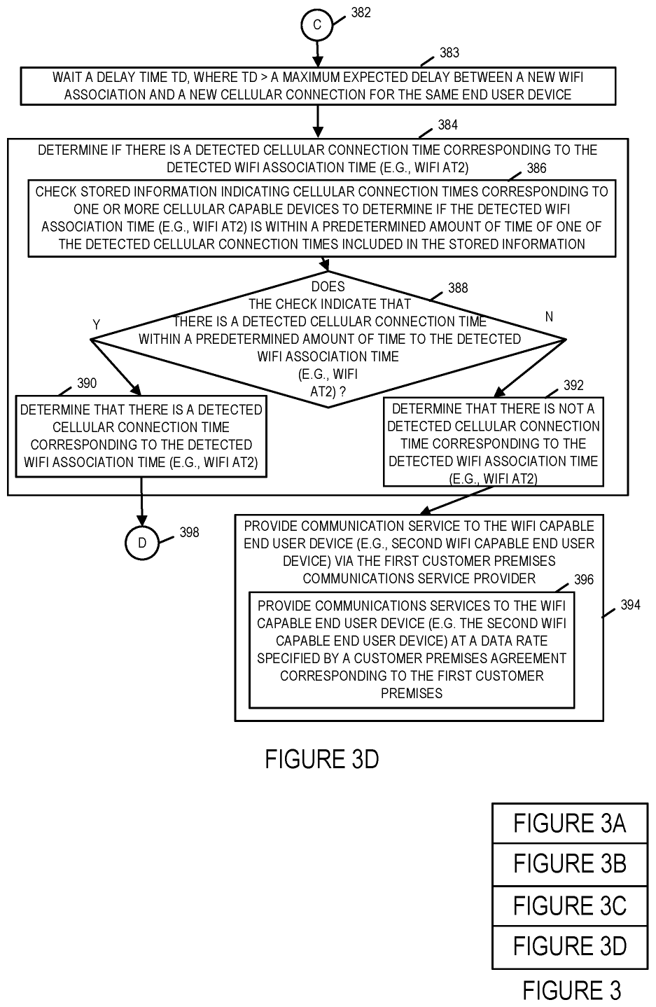

FIG. 3, comprising the combination of FIG. 3A, FIG. 3B, FIG. 3C and FIG. 3D, is a flowchart 300 of an exemplary communications method in accordance with an exemplary embodiment. The exemplary communications method of FIG. 3 may be performed by elements of communications system 100 of FIG. 1. Operation starts in step 301 in which the communications system is powered on and initialized. Operation proceeds from start step 301 to step 302 and to step 314, which may be performed in parallel.

In step 302 a WiFi access point (AP), e.g., WiFi AP 1 140, at a first customer premises, e.g. customer premises 198, is operated to monitor to detect a new association with a WiFi capable end user device. WiFi capable end user device is, e.g., any of end user devices (116, 118, 120, 122, 124, 126, 128, 130). Step 302 is performed repetitively on an ongoing basis. Step 302 may, and sometimes does include step 304. In step 304 the WiFi AP at the first customer premises detects a new association with a WiFi capable end user device, e.g., a first WiFi capable end user device or a second WiFi capable end user device. Operation proceeds from step 304 to step 306.

In step 306 the WiFi AP determines a time of WiFi association of the WiFi capable end user device (e.g., WiFi AT1 or WiFi AT2). Operation proceeds from step 306 to step 308. In step 308 the WiFi AP reports the time (e.g., WiFi AT 1 or WiFi AT2) of the new association and information (e.g., a MAC ID) identifying the WiFi capable end user device. In step 310 the WiFi AP stores the information (e.g., a MAC ID) identifying the WiFi capable end user device and the new WiFi association time in WiFi information table 312.

In step 314 a cellular base station, e.g., base station 138, at the first customer premises, e.g., customer premises 198, is operated to monitor to detect for a new connection with a cellular capable end user device, e.g., any of end user devices (116, 118, 120, 122). Step 314 is performed repetitively on an ongoing basis. Step 314 may, and sometimes does include step 316. In step 316 the cellular base station at the first customer premises detects a new connection with a cellular capable end user device, e.g., a first cellular capable end user device. Operation proceeds from step 316 to step 318.

In step 318 the cellular base station determines the time (e.g., cellular CT1) of the new cellular connection. Operation proceeds from step 318 to step 320. In step 320 the cellular base station reports the time (e.g., cellular CT1) of the new cellular connection and information (e.g., a UE ID) identifying the cellular capable end user device (e.g., first cellular capable end user device). Operation proceeds from step 320 to step 322. In step 322 the cellular base station stores the information (e.g., a UE ID) identifying the cellular capable end user device and the new cellular connection time (e.g., cellular CT1) in UE information table 338.

Operation proceeds from step 322 to step 324. In step 324 the cellular base station identifies a communications service provider used for the new connection with the cellular capable end user device. Step 324 includes step 326, in which the cellular base station determines the PLMN used for the new connection with cellular capable end user device. Step 236 includes steps 338, 330, 332 and 334. In step 338 the cellular base station determines whether or not the new connection is due to a handoff

If the new connection is not due to a handoff, then operation proceeds from step 338 to step 330. In step 330 the cellular base station obtains the value of the selectedPLMN_Identity field of the RRCSetupComplete message sent to cellular capable end user device as part of establishing the new cellular connection. Operation proceeds from step 330 to step 332. In step 332 the cellular base station uses the obtained value of the selectedPLMN_Identity field and a table of up to 12 carriers broadcast in the SIB1 to obtain the actual PLMN (which is the same PLMN that will be populated in the user location information field of the initial UE message sent to the core network with the registration message.

Alternatively, if the new connection is not due to a handoff, then operation proceeds from step 338 to step 334. In step 334 the cellular base station obtains the PLMN from the user location information filed of the path switch request.

Operations from step 324 to step 336, in which the cellular base station stores information, e.g., a PLMN ID, identifying the identified communications service provider (e.g., first communications service provider), in UE information table 338, e.g., with the information with step 322. Operation proceeds from step 336 via connecting node A 339 to step 340.

In step 340 the gateway/router is operated to wait a delay time TD, where TD> a maximum expected delay between a new cellular connection and a new WiFi association for the same end user device, e.g. same cellphone including cellular and WiFi capabilities. Upon completion of the delay TD, operation proceeds from step 340 to step 342.

In step 342, the gateway/router determines if there is a detected WiFi association corresponding to the detected WiFi association time corresponding to the detected cellular connection time (e.g., cellular CT1). Step 342 includes steps 344, 346, 348 and 350. In step 344 the gateway/router checks stored information indicating WiFi association times corresponding to one or more WiFi capable end user devices to determine if the detected cellular connection time (e.g., cellular CT1) is within a predetermined amount of time of one of the detected WiFi association times included in the stored information. Operation proceeds from step 344 to step 346. If the check indicates that there is a detected WiFi association time (e.g., WiFi AT1) within the predetermined amount of time to the detected cellular connection time (e.g., cellular CT1), then operation proceeds from step 346 to step 348, in which the gateway/router determines that there is a detected WiFi association time (e.g., WiFi AT1) corresponding to the detected cellular connection time (e.g., cellular CT1). Operation proceeds from step 348 to step 352. Alternatively, if the if the check indicates that there is not a detected WiFi association time within the predetermined amount of time to the detected cellular connection time (e.g., cellular CT1), then operation proceeds from step 346 to step 350, in which the gateway/router determines that there is not a detected WiFi association time corresponding to the detected cellular connection time (e.g., cellular CT1). Operation proceeds from step 350, via connecting node E 351 to step 314 for additional monitoring.

Returning to step 352, in step 352 the gateway/router identifies the WiFi capable end user device (e.g., first WiFi capable end user device) associated with the detected WiFi association time (e.g., WiFi AT1) corresponding to the detected cellular connection time (e.g., cellular CT1) as being the same end user device as the cellular capable end user device (e.g., first cellular capable end user device) corresponding to the detected cellular connection (e.g., first detected cellular connection). Operation proceeds from step 352 to step 354.

In step 354 the gateway/router identifies a communications service provider (e.g., a first communications service provider) used for the new connection with the cellular capable end user device (e.g., the first cellular capable end user device). Operation proceeds from step 354 to step 356.

In step 356 the gateway/router determines if the identified communications service provider (e.g., first communications service provider) corresponds to the customer premises communications service provider which provides communications service to the first customer premises. Step 356 includes step 358, step 360 and step 362. In step 358 if the identified communications service provider (e.g., first communications service provider) PLMN ID matches the PLMN ID of the communications service provider providing communications service to the first customer premises, then operation proceeds from step 358 to step 360 in which the gateway/router determines that the identified service provider (e.g., the first communication service provider) corresponds to (e.g., matches) the customer premises communications service provider which provides communications service to the first customer premises. However, in step 358 if the identified communications service provider (e.g., first communications service provider) PLMN ID does not match the PLMN ID of the communications service provider providing communications service to the first customer premises, then operation proceeds from step 358 to step 362 in which the gateway/router determines that the identified service provider (e.g., the first communication service provider) does not correspond to (e.g., does not match) the customer premises communications service provider which provides communications service to the first customer premises. Operation proceeds from step 356, via connecting node B 364 to step 366.

In step 366 the gateway/router is operated to control communications service provided to a WiFi capable end user device (e.g., the first WiFi capable end user device) via WiFi based on whether: i) it is determined that he identified communications service provider (e.g., the first communications service provider) matches the first customer premises communications service provider or ii) it is determined that the identified communications service provider (e.g., the first communications service provider) does not match the first customer premises service provider. Step 366 includes step 368, step 370 and step 372. If the identified communications service provider (e.g., the first communications service provider) does not match the first customer premises communications service provider, then operation proceeds from step 368 to step 370. However, if the identified communications service provider (e.g., the first communications service provider) does match the first customer premises communications service provider, then operation proceeds from step 368 to step 372.

Returning to step 370, in step 370 the gateway/router provides a lower bandwidth to the WiFi capable end user device (e.g., the first WiFi capable end user device) than to WiFi capable end user devices determined to correspond to the first customers premises communications service provider or provides communications services to the WiFi capable end user device (e.g., the first WiFi capable end user device) in accordance with a service agreement with the identified communications service provider (e.g., the first communications service provider). Step 370 includes step 374, step 376 and step 378. In step 374, the gateway/router determines whether or not there is a WiFi service agreement between the identified communications service provider (e.g., the first communications service provider) and the first customer premises service provider, with regard to providing WiFi service to subscribers of the identified communications service provider (e.g., the first communications service provider) at the first customer premises.

If the determination is that there is not a WiFi service agreement, then operation proceeds from step 374 to step 376, in which the gateway/router provides a lower bandwidth to the WiFi capable end user device (e.g., the first WiFi capable end user device) than is provided to a WifFi capable end user device determined to correspond to the first customer premises communications service provider. However, if the determination is that there is a WiFi service agreement, then operation proceeds from step 374 to step 378, in which the gateway/router provides communications service to the WiFi capable end user device (e.g., the first WiFi capable end user device) in accordance with the WiFi service agreement with the identified communications service provider (e.g., the first communications service provider). In some embodiments, step 378 includes step 380, in which the gateway/router provides communications service to the WiFi capable end user device (e.g., the first WiFi capable end user device) in accordance with the WiFi service agreement with the identified communications service provider (e.g., the first communications service provider), said WiFi service agreement providing an amount of bandwidth which is different than an amount of bandwidth provided to a first customer premises WiFi end user device based on a user agreement corresponding to the first customer premises.

Returning to step 372, in step 372 the gateway/router provides communications bandwidth to the WiFi capable end user device (e.g., the first WiFi capable end user device) at a rate provided to WiFi devices corresponding to the first customer premises.

Returning to step 310 (of FIG. 3A), operation proceeds from step 310, via connecting node C 382, to step 383 (of FIG. 3D). In step 383 the gateway/router waits a delay time TD, where TD is greater than a maximum expected delay between a new WiFi association and a new cellular connection for the same end user device. Upon completion of the delay TD, operation proceeds from step 383 to step 384.

In step 384 the gateway/router determines if there is detected cellular connection time corresponding to the detected WiFi association time (e.g., WiFi AT2). Step 384 includes steps 386, 388, 390 and 392. In step 386 the gateway/router checks stored information indicating cellular connection times corresponding to one or more cellular capable devices to determine if the detected WiFi association time (e.g., WiFi AT2) is within a predetermined amount of time of one of the detected cellular connection times included in the stored information. Operation proceeds from step 386 to step 388. If the check indicates that there is a detected cellular connection time within the predetermined amount of time to the detected WiFi association time (e.g., WiFi AT2), then operation proceeds from step 388 to step 390, in which the gateway/router determines that there is a detected WiFi cellular connection time corresponding to the detected WiFi association time (e.g., WiFi AT2). Operation proceeds from step 350, via connecting node D 398 to step 302 for additional monitoring. Alternatively, if the if the check indicates that there is not a detected cellular connection time within the predetermined amount of time to the detected WiFi association time (e.g., WiFi AT2), then operation proceeds from step 388 to step 392, in which the gateway/router determines that there is not a cellular connection time corresponding to the detected WiFi association time (e.g., WiFi AT2). Operation proceeds from step 392 to step 394.

In step 394 the gateway/router provides communications service to the WiFi capable end user device (e.g., the second WiFi capable end user device) via the first customer premises communications service provider. Step 394 includes step 396, in which the gateway/router provides communications services to the WiFi capable end user device (e.g., the second WiFi capable end user device) at a data rata specified by a customer premises agreement corresponding to the first customer premises.

In some embodiments, steps 318, 320, 322, 324, 336, 342, 352, 354, 356, and 366 are preformed by a connection detected processing subroutine, e.g. which is called and executed in response to each detected new cellular connection. In some embodiments, steps 306, 308, 310, 383, 384 and 394 are preformed by an association detected processing subroutine, e.g. which is called and executed in response to each detected new WiFi association.

FIG. 4 is a drawing of an exemplary WiFi information table 400 on a WiFi AP of an exemplary residential gateway (RG) in accordance with an exemplary embodiment. WiFi information table 400 is, e.g., WiFi info table 210 of FIG. 2 or WiFi info table 312 of FIG. 3. WiFi information table 400 includes generated entries in response to WiFi AP detected new association of WiFi capable end user devices. First column 402 includes 48-bit MAC IDs corresponding to the WiFi capable end user devices, which were detected to associate with the WiFi AP. Second column 404 lists a time for each detected new WiFi association of a WiFi capable end user device. First row 406 includes column headings: MAC ID (48 bits) and time. Second row 408 includes information including the detected Laptop 1 WiFi MAC ID and the corresponding determined time of WiFi attachment, which is 16:05:30. Third row 410 includes information including the detected Laptop 2 WiFi MAC ID and the corresponding determined time of WiFi attachment, which is 16:55:27. Fourth row 412 includes information including the detected cellphone 1 WiFi MAC ID and the corresponding determined time of WiFi attachment, which is 17:08:33. Fifth row 414 includes information including the detected TV WiFi MAC ID and the corresponding determined time of WiFi attachment, which is 17:09:27. Sixth row 416 includes information including the detected cellphone 2 MAC ID and the corresponding determined time of WiFi attachment, which is 17:23:37. Seventh row 418 includes information including the detected desktop 1 MAC ID and the corresponding determined time of WiFi attachment, which is 18:35:47. Eighth row 420 includes information including the detected cellphone 3 MAC ID and the corresponding determined time of WiFi attachment, which is 18:55:13. Ninth row 422 includes information including the detected cellphone 4 MAC ID and the corresponding determined time of WiFi attachment, which is 19:30:45.

FIG. 5 is a drawing of an exemplary UE (user equipment) information table 500 on a femtocell HgNB CBRS base station of an exemplary residential gateway (RG) in accordance with an exemplary embodiment. UE information table 500 is, e.g., UE info table 228 of FIG. 2 or UE info table 338 of FIG. 3. UE information table 500 includes generated entries in response to base station detected new cellular connections of cellular capable end user devices. First column 502 includes 39-bit UE-IDs corresponding to the cellular capable end user devices, which were detected by the base station. Second column list 32 bit RAN UE IDs corresponding to the cellular capable end user devices, which were detected by the base station. Third column 506 lists a time for each detected new cellular connection with a cellular capable end user device. Fourth column 508 list the communications service provider (sometimes referred to as carrier) and/or information (e.g., a PLMN ID) identifying the communications service provider (carrier) to which the user of the cellular capable end user device is a subscriber. First row 502 includes column headings: UE ID (39 bits), RAN UE NGAP ID (32 bits), time, and communications service provider (carrier) (PLMNID). Second row 502 includes information including the cellphone 1 UE ID, corresponding RAN_UE_ID which is RAN_UE_ID 1, the corresponding determined time of cellular connection, which is 17:08:41, and the corresponding communications service provider, which is service provider B. Second row 512 includes information including the cellphone 1 UE ID, corresponding RAN_UE_ID, which is RAN_UE_ID_1, the corresponding determined time of cellular connection, which is 17:08:41, and the corresponding communications service provider, which is service provider B. Third row 514 includes information including the cellphone 2 UE ID, corresponding RAN_UE_ID, which is RAN_UE_ID_2, the corresponding determined time of cellular connection, which is 17:23:30, and the corresponding communications service provider, which is service provider B. Fourth row 516 includes information including the cellphone 3 UE ID, corresponding RAN UE_ID, which is RAN_UE_ID_3, the corresponding determined time of cellular connection, which is 18:55:19, and the corresponding communications service provider, which is service provider A. Fifth row 518 includes information including the cellphone 4 UE ID, corresponding RAN UE_ID, which is RAN UE_ID_4, the corresponding determined time of cellular connection, which is 19:30:40, and the corresponding communications service provider, which is service provider C.

FIG. 6 is a drawing of an exemplary MAC ID-cellphone correlation table 600 of the exemplary residential gateway (RG) in accordance with an exemplary embodiment. MAC ID-cellphone correlation table 600 is, e.g., correlation table 242 of FIG. 2. Each set of row entries in exemplary correlation table 600 corresponds to an identified new detected WiFi association time (from WiFi info table 402 of FIG. 4) matching, e.g. withing an allowed time window, a new cellular connection time (from UE info table 500 of FIG. 5).

The WiFi association time of 17:08:33 (from table 400) is match with respect to the cellphone 1 connection time, which is 17:08:41 (from table 500), e.g., the delta of-8 seconds is within an allowable window, e.g., +/−10 seconds, for a match to be determined. The WiFi association time of 17:23:37 (from table 400) is match with respect to the cellphone 2 connection time, which is 17:23:30 (from table 500), e.g., the delta of 7 seconds is within an allowable window, e.g., +/−10 seconds, for a match to be determined. The WiFi association time of 18:55:13 (from table 400) is match with respect to the cellphone 3 connection time, which is 17:55:19 (from table 500), e.g., the delta of-6 seconds is within an allowable window, e.g., +/−10 seconds, for a match to be determined. The WiFi association time of 19:30:45 (from table 400) is match with respect to the cellphone 4 connection time, which is 19:30:40 (from table 500), e.g., the delta of 5 seconds is within an allowable window, e.g., +/−10 seconds, for a match to be determined.

First column 602 includes 48-bit MAC-IDs corresponding to identified end user devices (cellphones) which are both WiFi capable and cellular capable. Second column 604 includes 32-bit RAN_UE_IDs corresponding to identified end user devices (cellphones) which are both WiFi capable and cellular capable. Third column 606 lists, for each end user device which is identified as being both a WiFi and cellular capable device, the communications service provider (sometimes referred to as carrier) and/or information (e.g., a PLMN ID) identifying the communications service provider (carrier) to which the user of identified end user device (cellphone) which is both WiFi capable and cellular capable is a subscriber.

First row 608 includes column headings: MAC ID (48 bits), RAN UE NGAP ID (32 bits), and communications service provider (carrier) (PLMNID). Second row 610 includes information including the detected cellphone 1 MAC ID (obtained from table 400), the detected corresponding RAN_UE_ID, which is RAN UE ID 1 (obtained from table 500), and the corresponding service provider for the end user device (cellphone) which supports both cellular and WiFi communications, which is service provider B (obtained from table 500). Second row 610 includes information including the detected cellphone 1 MAC ID (obtained from table 400), the detected corresponding RAN UE_ID, Ih Is RAN UE_ID_1 (obtained from table 500), and the corresponding service provider for the end user device (cellphone) which supports both cellular and WiFi communications, which is service provider B (obtained from table 500). Third row 612 includes information including the detected cellphone 2 MAC ID (obtained from table 400), the detected corresponding RAN_UE_ID, which is RAN_UE_ID_2 (obtained from table 500), and the corresponding service provider for the end user device (cellphone) which supports both cellular and WiFi communications, which is service provider B (obtained from table 500). Fourth row 614 includes information including the detected cellphone 3 MAC ID (obtained from table 400), the detected corresponding RAN UE_ID, which is RAN_UE_ID_3 (obtained from table 500), and the corresponding service provider for the end user device (cellphone) which supports both cellular and WiFi communications, which is service provider A (obtained from table 500). Fifth row 616 includes information including the detected cellphone 4 MAC ID (obtained from table 400), the detected corresponding RAN UE_ID, which is RAN_UE_ID_4 (obtained from table 500), and the corresponding service provider for the end user device (cellphone) which supports both cellular and WiFi communications, which is service provider C (obtained from table 500).

FIG. 7 is a drawing of an exemplary service provider to WiFi service level mapping information table 700 in accordance with an exemplary embodiment. First column 702 indicates the WiFi end user device's communications service provider. Second column 704 indicates the WiFi service level to be provided by the residential gateway (RG) to the end user device. First row 706 includes column headers: WiFi end user device's communications service provider and WiFi service level.

Second row 708 indicates that a service provider A end user device (e.g., a cellphone including cellular and WiFi capabilities of a subscriber to service provider A) receives a WiFi service level in accordance with the service provider A subscriber contract level, wherein service provider A is the customer premises 1 service provider and wherein the RG is located at customer premises 1.

Third row 710 corresponds to an example in which service provider B has a WiFi service agreement with service provider A, with regard to supporting a level(s) of WiFi communications (e.g., in terms of amount of bandwidth and/or data rate supported) to end user devices (e.g., cellphones supporting WiFi) of service provider B, which are visiting a service provider A coverage area such as customer premises 1 which provides WiFi. Third row 710 indicates that a service provider B end user device (e.g., a cellphone including cellular and WiFi capabilities of a subscriber to service provider B) receives a WiFi service level in accordance with a WiFi service agreement between service provider A and service provider B. In some embodiments, the service agreement between service provider A and service provider B indicates that a service provider B end user device (e.g., a cellphone including cellular and WiFi capabilities of a subscriber to service provider B) receives a different amount of bandwidth for WiFi than is provided to a subscriber of service provider A. In some such embodiments, the different amount of bandwidth is a higher amount of bandwidth. In some embodiments, any of the subscribers of service provider B are allocated the different amount of bandwidth, e.g., in accordance with the service provider A to service provider B service agreement. In some embodiments, different subscribers of service provider B may be allocated different amounts of bandwidth, e.g., in accordance with subscription information corresponding to individual end user devices. For example, some select subscriber of service provider B may be allowed more bandwidth than subscribers of service provider A, while other subscribers of service provider A may be allocated the same amount of bandwidth as is allocated to subscribers of service provider A, while still other subscriber of service provider B may be allocated a lower level of bandwidth than the amount of bandwidth allocated to subscriber of service provider A.

Fourth row 712 corresponds to an example in which other service providers (e.g., service provider C) which do not have a WiFi service agreement with service provider A, with regard to supporting a level(s) of WiFi communications (e.g., in terms of amount of bandwidth and/or data rate supported) to end user devices (e.g., cellphones supporting WiFi) of the service provider, e.g., service provider C, which are visiting a service provider A coverage area such as customer premises 1 which provides WiFi. Fourth row 712 indicates that such a service provider's (e.g., service provider C's) end user device (e.g., a cellphone including cellular and WiFi capabilities of a subscriber to service provider C) receives a default level of WiFi service level, e.g., a lower level of bandwidth for WiFi, than is being provided to service provider A's subscribers.

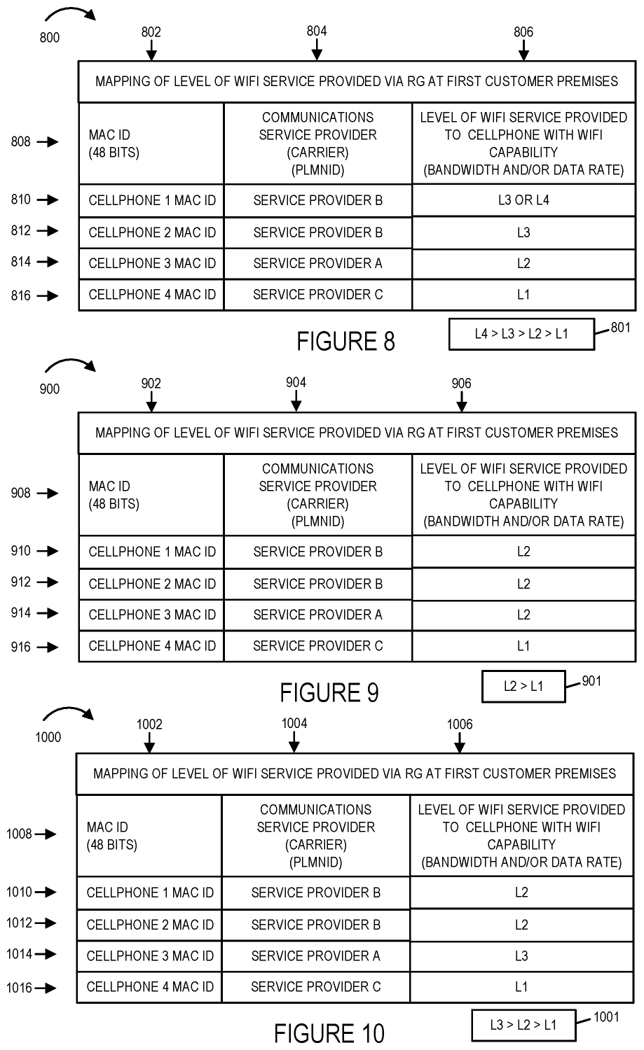

FIG. 8 is a drawing of an exemplary WiFi service level mapping table 800 in accordance with an exemplary embodiment. WiFi service level mapping 800 illustrates the level of WiFi service provided via the RG at the first customer premises for different exemplary cellphones which include WiFi capability, e.g. based on whether or not the service provider corresponding to the cellphone is the same or different than the service provider of the RG, whether or not the service provider corresponding to the cellphone has a WiFi service agreement with the service provider of the RG, and/or terms of the WiFi service agreement.

First column 802 identifies MAC ID, e.g., current MAC ID, corresponding to each of the cellphones, second column 804 identifies the communications service provider corresponding to each of the cellphones, and third column 806 identifies the level of WiFi service (e.g., in terms or bandwidth and/or data rate) to be provided to each of the cellphones. Information box 801 specifies, with regard to the levels of WiFi service, that L4>L3>L2>L1.

First Row 808 includes header information for each column: MAC ID (48 bits); communications service provider, which is sometimes referred to as carrier or by its PLMNID; and level of WiFi service provided to cellphone with WiFi capability (with the WiFi level referring to amount of bandwidth and/or data rate).

Second row 810 indicates: the current 48 bit cellphone 1 MAC ID, that the owner of cellphone 1 is a subscriber of service provider B, and that cellphone 1 will receive the L3 or L4 level of WiFi service via the RG. Third row 812 indicates: the current 48 bit cellphone 2 MAC ID, that the owner of cellphone 2 is a subscriber of service provider B, and that cellphone 2 will receive the L3 level of WiFi service via the RG. Fourth row 814 indicates: the current 48 bit cellphone 3 MAC ID, that the owner of cellphone 3 is a subscriber of service provider A, and that cellphone 3 will receive the L2 level of WiFi service via the RG. Fifth row 816 indicates: the current 48 bit cellphone 4 MAC ID, that the owner of cellphone 4 is a subscriber of service provider C, and that cellphone 4 will receive the L1 level of WiFi service via the RG.

In this example, service provider A is the service provider of the RG; service provider B has a WiFi service agreement service provider A to receive a higher level of WiFi service from the RG than the RG provides to service provider A subscribers; and service provider C does not have a WiFi service agreement with regard to service provider A with regard to providing a level of WiFi service and thus cellphones of service provider C receive the default level of WiFi service, which is a lower level of WiFi service than is provided to service provider A subscribers. In some embodiments, the service agreement between service provider B and service provider A provides the same high level of WiFi service, e.g. level L3 service, to each of the cellphones corresponding to service provider B. In some other embodiments individual cellphones of service provider B are provided different high levels of WiFi service from the RG, e.g. L3 or L4.

FIG. 9 is a drawing of another exemplary WiFi service level mapping table 900 in accordance with an exemplary embodiment. WiFi service level mapping 900 illustrates the level of WiFi service provided via the RG at the first customer premises for different exemplary cellphones which include WiFi capability, e.g. based on whether or not the service provider corresponding to the cellphone is the same or different than the service provider of the RG, whether or not the service provider corresponding to the cellphone has a WiFi service agreement with the service provider of the RG, and/or terms of the WiFi service agreement.

First column 902 identifies MAC ID, e.g., current MAC ID, corresponding to each of the cellphones, second column 904 identifies the communications service provider corresponding to each of the cellphones, and third column 906 identifies the level of WiFi service (e.g., in terms or bandwidth and/or data rate) to be provided to each of the cellphones. Information box 802 specifies, with regard to the levels of WiFi service, that L2>L1.

First Row 908 includes header information for each column: MAC ID (48 bits); communications service provider, which is sometimes referred to as carrier or by its PLMNID; and level of WiFi service provided to cellphone with WiFi capability (with the WiFi level referring to amount of bandwidth and/or data rate).

Second row 910 indicates: the current 48 bit cellphone 1 MAC ID, that the owner of cellphone 1 is a subscriber of service provider B, and that cellphone 1 will receive the L2 level of WiFi service via the RG. Third row 912 indicates: the current 48 bit cellphone 2 MAC ID, that the owner of cellphone 2 is a subscriber of service provider B, and that cellphone 2 will receive the L2 level of WiFi service via the RG. Fourth row 914 indicates: the current 48 bit cellphone 3 MAC ID, that the owner of cellphone 3 is a subscriber of service provider A, and that cellphone 3 will receive the L2 level of WiFi service via the RG. Fifth row 916 indicates: the current 48 bit cellphone 4 MAC ID, that the owner of cellphone 4 is a subscriber of service provider C, and that cellphone 4 will receive the L1 level of WiFi service via the RG.

In this example, service provider A is the service provider of the RG; service provider B has a WiFi service agreement service provider A to receive the same level of WiFi service from the RG than the RG provides to service provider A subscribers; and service provider C does not have a WiFi service agreement with regard to service provider A with regard to providing a level of WiFi service and thus cellphones of service provider C receive the default level of WiFi service, which is a lower level of WiFi service than is provided to service provider A subscribers.

FIG. 10 is a drawing of an exemplary WiFi service level mapping table 1000 in accordance with an exemplary embodiment. WiFi service level mapping 1000 illustrates the level of WiFi service provided via the RG at the first customer premises for different exemplary cellphones which include WiFi capability, e.g. based on whether or not the service provider corresponding to the cellphone is the same or different than the service provider of the RG, whether or not the service provider corresponding to the cellphone has a WiFi service agreement with the service provider of the RG, and/or terms of the WiFi service agreement.

First column 1002 identifies MAC ID, e.g., current MAC ID, corresponding to each of the cellphones, second column 1004 identifies the communications service provider corresponding to each of the cellphones, and third column 1006 identifies the level of WiFi service (e.g., in terms or bandwidth and/or data rate) to be provided to each of the cellphones. Information box 1001 specifies, with regard to the levels of WiFi service, that L3>L2>L1.

First Row 1008 includes header information for each column: MAC ID (48 bits); communications service provider, which is sometimes referred to as carrier or by its PLMNID; and level of WiFi service provided to cellphone with WiFi capability (with the WiFi level referring to amount of bandwidth and/or data rate).

Second row 1010 indicates: the current 48 bit cellphone 1 MAC ID, that the owner of cellphone 1 is a subscriber of service provider B, and that cellphone 1 will receive the L2 level of WiFi service via the RG. Third row 1012 indicates: the current 48 bit cellphone 2 MAC ID, that the owner of cellphone 2 is a subscriber of service provider B, and that cellphone 2 will receive the L2 level of WiFi service via the RG. Fourth row 1014 indicates: the current 48 bit cellphone 3 MAC ID, that the owner of cellphone 3 is a subscriber of service provider A, and that cellphone 3 will receive the L3 level of WiFi service via the RG. Fifth row 1016 indicates: the current 48 bit cellphone 4 MAC ID, that the owner of cellphone 4 is a subscriber of service provider C, and that cellphone 4 will receive the L1 level of WiFi service via the RG.

In this example, service provider A is the service provider of the RG; service provider B has a WiFi service agreement service provider A to receive an intermediate level of WiFi service from the RG; and service provider C does not have a WiFi service agreement with regard to service provider A with regard to providing a level of WiFi service and thus cellphones of service provider C receive the default level of WiFi service, which is a lower level of WiFi service. In the example of FIG. 10, the service provider A subscriber devices (cellphones), which have the same service provider as the service provider of the customer premises RG receive the highest level of WiFi service, the service provider B subscriber devices (cellphones), receive an intermediate level of WiFi service in accordance with the service provider A-service provider B WiFi service level agreements, the service provider C subscriber devices (cellphones) receive the lowest level of WiFi service.

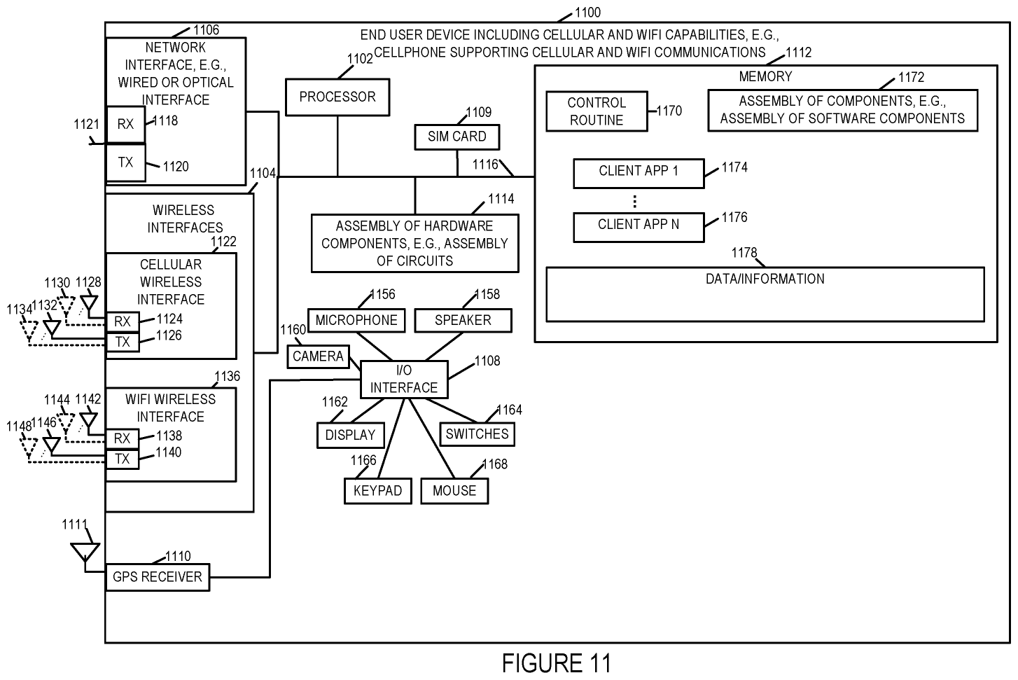

FIG. 11 is a drawing of an exemplary end user device 1100 including cellular and WiFi capabilities, e.g., a cellphone supporting cellular and WiFi communications, in accordance with an exemplary embodiment. Exemplary end user device 1100 is, e.g., any of cellphone 1 116, cellphone 2 118, cellphone 3 120 or cellphone 4 122 of system 100 of FIG. 1. Exemplary end user device 1100 includes a processor 1102, e.g., a CPU, wireless interfaces 1104, network interface 1106, I/O interface 1108, SIM card 1109, GPS receiver 1110, memory 1112 and an assembly of hardware components 1114, e.g., an assembly of circuits, coupled together via a bus 1116 over which the various elements may interchange data and information.

Wireless interface 1104 includes a cellular wireless interface 1122 and a WiFi wireless interface 1136. Cellular wireless interface 1122 includes a wireless receiver (RX) 1124 coupled to one or more receive antennas (1128, . . . , 1130), via which the end user device 1100 receives wireless cellular signals from base stations, e.g., macro base stations and femtocell base stations, and a wireless transmitter (TX) 1126 coupled to one or more transmit antennas (1132, . . . , 1132) via which the end user device 1100 transmits wireless cellular signals to base stations, e.g., macro cell base stations and femtocell base stations. In some embodiments, the cellular wireless interface supports CBRS. In some embodiments, the same antennas or antenna elements are used for both reception and transmission of wireless cellular signals.

WiFi wireless interface 1136 includes a wireless receiver (RX) 1138 coupled to one or more receive antennas (1142, . . . , 1144), via which the end user device 1100 receives wireless WiFi signals from WiFi access points and a wireless transmitter (TX) 1140 coupled to one or more transmit antennas (1146, . . . , 1148) via which the end user device 1100 transmits wireless WiFi signals to WiFi access points. In some embodiments, the same antennas or antenna elements are used for both reception and transmission of wireless WiFi signals.

Subscriber Identity Module (SIM) card 1109, corresponds to a particular communications service provider (e.g., a MNO or a MVNO) to which the owner of end user device 1100 is a subscriber, includes subscriber information, e.g. user identity, location and phone number, network authorization data, personal security keys, contact lists, etc.

GPS receiver 1110 is coupled to GPS antenna 1111 via which the end user device receives GPS signals. The GPS receiver uses the received GPS signals to determine time, end user device position, e.g., latitude, longitude, and altitude, and end user device velocity information.

End user device 1100 further includes a plurality of I/O devices (microphone 1156, speaker 1158, camera 1160, display 1162, e.g., a touchscreen display, switches 1164 keypad 1166 and mouse 1168, which are coupled to I/O interface 1108. I/O interface 1108 couples the various I/O devices to other elements within end user device 1100 via bus 1116.

Memory 1112 includes control routine 1170, assembly of components 1172, a plurality of client applications (client app 1 1174, . . . , client app N 1176) and data/information 1178.

Control routine 1170 includes instructions which when executed by processor 1102 control the end user device 1100 to implement basic operational functions, e.g., read memory, write to memory, control an interface, load a program, subroutine, or app, etc. Assembly of components 1172, e.g., an assembly of software components, e.g., routines, subroutines, applications, etc., includes, e.g., code, e.g., machine executable instructions, which when executed by processor 1102, controls the end user device 1100 to implement steps of a method, e.g., steps of method described with respect to flowchart 200 of FIG. 2 and/or flowchart 300 of FIG. 3.

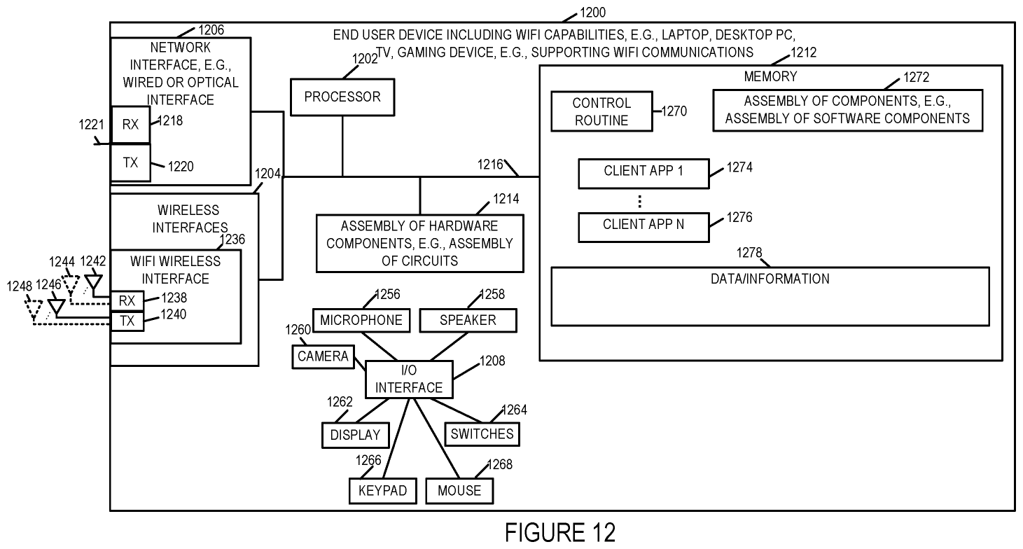

FIG. 12 is a drawing of an exemplary end user device 1200 including WiFi capabilities, e.g., a laptop supporting WiFi communications, a desktop PC supporting WiFi communications, a TV supporting WiFi communications, a gaming device supporting WiFi communications, etc., in accordance with an exemplary embodiment. Exemplary end user device 1200 is, e.g., any of laptop 1 124, laptop 2 124, desktop 126, or TV 128 of system 100 of FIG. 1. Exemplary end user device 1200 includes a processor 1202, e.g., a CPU, wireless interfaces 1204, network interface 1306, I/O interface 1308, memory 1312 and an assembly of hardware components 1214, e.g., an assembly of circuits, coupled together via a bus 1216 over which the various elements may interchange data and information.

Wireless interfaces 1204 includes a WiFi wireless interface 1236. WiFi wireless interface 1236 includes a wireless receiver (RX) 1238 coupled to one or more receive antennas (1242, . . . , 1244), via which the end user device 1200 receives wireless WiFi signals from WiFi access points and a wireless transmitter (TX) 1240 coupled to one or more transmit antennas (1246, . . . , 1248) via which the end user device 1200 transmits wireless WiFi signals to WiFi access points. In some embodiments, the same antennas or antenna elements are used for both reception and transmission of wireless WiFi signals.

End user device 1200 further includes a plurality of I/O devices (microphone 1256, speaker 1258, camera 1260, display 1262, e.g., a touchscreen display, switches 1264 keypad 1266 and mouse 1268, which are coupled to I/O interface 1208. I/O interface 1208 couples the various I/O devices to other elements within end user device 1200 via bus 1216.

Memory 1212 includes a control routine 1270, an assembly of components 1272, e.g., an assembly of software components, a plurality of client applications (client app 1 1274, . . . , client app N 1276) and data/information 1278.

Control routine 1270 includes instructions which when executed by processor 1202 control the end user device 1200 to implement basic operational functions, e.g., read memory, write to memory, control an interface, load a program, subroutine, or app, etc. Assembly of components 1272, e.g., an assembly of software components, e.g., routines, subroutines, applications, etc., includes, e.g., code, e.g., machine executable instructions, which when executed by processor 1202, controls the end user device 1200 to implement steps of a method, e.g., steps of method described with respect to flowchart 200 of FIG. 2 and/or flowchart 300 of FIG. 3.

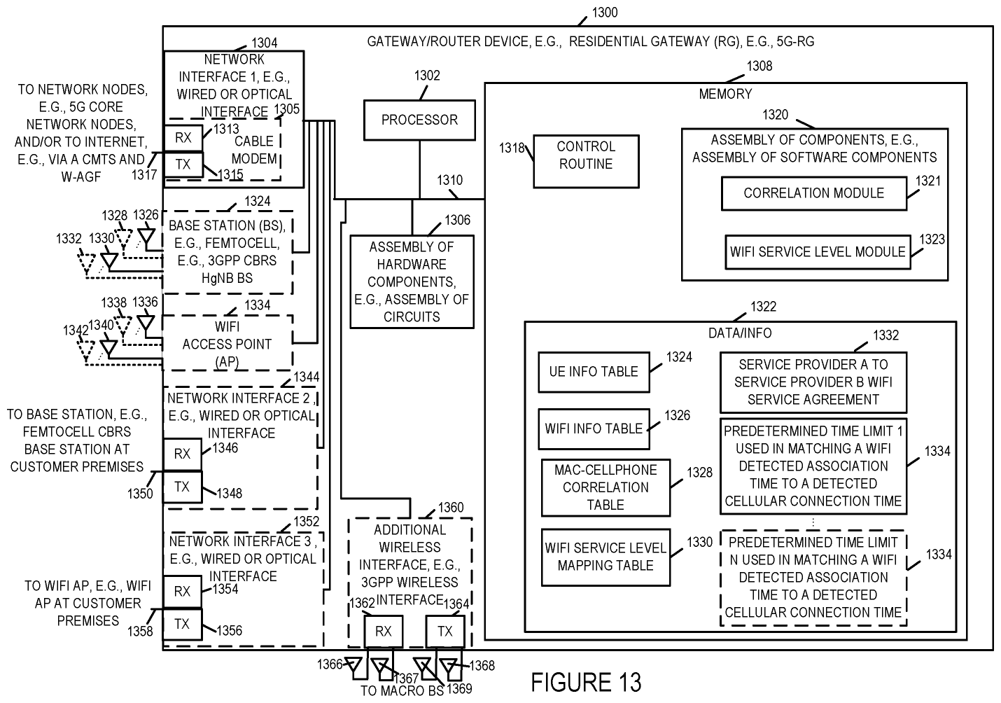

FIG. 13 is a drawing of an exemplary gateway/router device 1300, e.g., a residential gateway (RG), e.g., a 5G-RG, in accordance with an exemplary embodiment. Exemplary gateway/router device 1300 is, e.g., gateway/router 1 102 or gateway/router N 104 of system 100 of FIG. 1 and/or a gateway/router device implementing steps of the method of flowchart 200 of FIG. 2 and/or flowchart 300 of FIG. 3. Exemplary gateway/router 1300 includes a processor 1302, e.g., a CPU, network interface 1 1304, an assembly of hardware components 1306, e.g., an assembly of circuits, and memory 1308 coupled together via a bus 1310 over which the various elements may interchange data and information. In some embodiments, gateway/router device 1300 includes one or more or all of base station 1324, WiFi access point 1334, network interface 2 1344 and network interface 3 1352. In some embodiments both base station 1324 and WiFi access point 1334 are included as part of gateway/router device 1300 and interfaces 1344, 1352 are not included. In some embodiments base station 1324 and network interface 3 1352 are included in gateway/router device 1300, and a WiFi AP, which is external to the gateway/router device 1300 and is co-located at the same customer premises as the gateway/router device 1300, is coupled to the gateway/router device 1300 via network interface 3 1352. In some embodiments WiFi AP 1334 and network interface 2 1344 are included in gateway/router device 1300, and a base station, e.g., a femtocell HgNB CBRS base station, which is external to the gateway/router device 1300 and is co-located at the same customer premises as the gateway/router device 1300, is coupled to the gateway/router device 1300 via network interface 2 1334.

In some embodiments gateway/router device 1300, e.g., a RG, includes additional wireless interface 1360, e.g., a 3GPP wireless interface, including a wireless receiver 1362 coupled to one or more receive antennas or antenna elements (1366, . . . , 1367) and a wireless transmitter 1364 coupled to one or more transmit antennas or antenna elements (1368, . . . , 1369). Additional wireless interface 1360 allows the gateway/router device 1300 to communicate with 3GPP RANs, e.g., a macro cell base station. Additional wireless interface 1360, when included, provides an alternative path to the core network, in addition to the wireline path provided via network interface 1304.

Base station (BS) 1324, e.g., a femtocell, e.g., a 3GPP CBRS HgNB base station, includes a wireless cellular receiver and a wireless cellular transmitter. The wireless receiver of BS 1324 is coupled to one or more receive antennas or antenna elements (1326, . . . , 1328) via which the base station receives wireless uplink signals from cellular capable end user devices, e.g., cellphones. The wireless transmitter of BS 1324 is coupled to one or more transmit antennas or antenna elements (1326, . . . , 1328) via which the base station transmits wireless downlink signals to one or more cellular capable end user devices, e.g., cellphones.

WiFi access point (AP) 1334 includes a wireless WiFi receiver and a wireless WiFi transmitter. The wireless WiFi receiver is coupled to one or more receive antennas or antenna elements (1336, . . . , 1338) via which the WIFI AP 1334 receives wireless WiFi uplink signals from WiFi capable end user devices, e.g., cellphones supporting WiFi communications and other devices, e.g., laptops, desktop PCs, TVs, gaming devices, etc. which support WiFi communications. The wireless transmitter of WiFi AP 1334 is coupled to one or more transmit antennas or antenna elements (1340, . . . , 1342) via which the WiFi AP transmits wireless WiFi downlink signals to one or more WiFi capable end user devices, e.g., cellphones supporting WiFi communications and other devices, e.g., laptops, desktop PCs, TVs, gaming devices, etc. which support WiFi communications.

Network interface 1 1304, e.g., a wired or optical interface, includes a receiver 1313, a transmitter 1315 and connector 1317 coupled together. In some embodiments, network interface 1 1304 is a core network interface. In some embodiments, network interface 1 1304 includes a cable modem 105, which includes the receiver 1313 and the transmitter 1315. Network interface 1 1304 couples the gateway/router 1300 to network nodes, e.g., 5G core network nodes and/or the Internet, e.g., via a cable modem termination system (CMTS).

Network interface 2 1344, e.g., a wired or optical interface, includes a receiver 1346, a transmitter 1348 and connector 1350 coupled together. Network interface 2 1344 couples the gateway/router 1300 to a base station, e.g., a femtocell CBRS base station, which is located at the same customer premises as gateway/router device 1300.

Network interface 3 1352, e.g., a wired or optical interface, includes a receiver 1354, a transmitter 1356 and connector 1358 coupled together. Network interface 3 1352 couples the gateway/router 1300 to a WiFi AP, which is located at the same customer premises as gateway/router device 1300.

Memory 1308 includes control routine 1318, assembly of components 1320, and data/information 1322. Control routine 1318 includes instructions which when executed by processor 1302 control the gateway/router device 1300 to implement basic operational functions, e.g., read memory, write to memory, control an interface, load a program, subroutine, or app, etc. Assembly of components 1320, e.g., an assembly of software components, e.g., routines, subroutines, applications, etc., includes, e.g., code, e.g., machine executable instructions, which when executed by processor 1302, controls the gateway/router device 1300 to implement steps of a method, e.g., steps of method described with respect to flowchart 300 of FIG. 3 and/or flowchart 300 of FIG. 3.

Assembly of components 1320 includes correlation module 1321 and WiFi service level module 1323. Correlation module 1321 compares attachment time information in a WiFi information table to connection time information in a UE info table to determine matches, e.g. identify a WiFi attachment time which occurs close, e.g., to within a predetermined time window, with respect to a cellular connection time, determines that it is likely that that the same device (e.g., a cellphone with cellular and WiFi capabilities) corresponds to both the WiFi attachment and the UE connection with the close times, and maps the MAC address associated with the WiFi attachment to the UE Id Information, the UE Id can be associated with a particular service provider. The WiFi service level module 1323 controls the level of WiFi service to be provided to each end user device using WiFi through the gateway/router, e.g. with different levels of levels of service potentially being provided based on the service provider of the end user device. The service level provided to an end user device (cellphone), which is using WiFi communications services through the gateway/router 1300, can be, and sometimes is, based on the particular service provider to which the owner of the end user device (cellphone) subscribes and/or a WiFi service agreement between the service provider of the gateway/router 1300 and the service provider of the end user (cellphone) device.

Data/information 1322 includes UE information table 1324, e.g., table 500 of FIG. 5, WiFi information table 1326, e.g., table 400 of FIG. 4, MAC-cellphone correlation table 1328, e.g., table 600 of FIG. 6, and WiFi service level mapping table 1330, e.g., any of table 800 of FIG. 8, table 900 of FIG. 9 or table 1000 of FIG. 10, and service provider A-service provider B WiFi service agreement 1332, which includes information identifying the terms of WiFi service to be provided to identified end user devices of service provider B, while at a service provider A customer premises. Data/information 1332 further includes one or more predetermined time limits used for matching a detected WiFi association time to a detected cellular connection time (predetermined time limit 1 1334 used for matching a detected WiFi association time to a detected cellular connection time, . . . , predetermined time limit N 1336 used for matching a detected WiFi association time to a detected cellular connection time). In some embodiments a single predetermined time limit, e.g., predetermined time limit 1 1334 is used universally to perform the matching. In some other embodiments, a set of predetermined time limits are used for the matching, e.g., with different ones of the predetermined time limits corresponding to different cellular service providers, different types of cellphones, different versions of cellphones, and/or different versions of cellphone software. In some embodiments, the one or more predetermined time limits used for the matching were determined using artificial intelligence (AI) and/or machine learning (ML). In some embodiments, AI and/or ML is used to adjust the one or more predetermined time limits being used for matching by the gateway/router device, e.g., with updates being performed infrequently, e.g. at intervals of days or months.

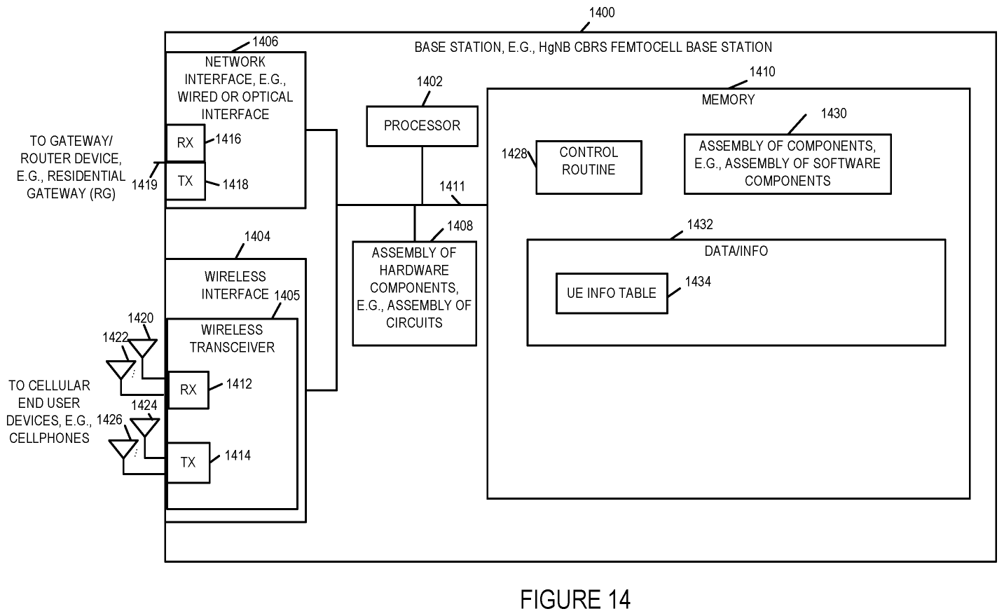

FIG. 14 is a drawing of an exemplary base station 1400, e.g., a HgNB CBRS femtocell base station, in accordance with an exemplary embodiment. Exemplary base station 1400 is, e.g., any of base station 138 of system 100 of FIG. 1, base station 1324 of gateway/router 1300 of FIG. 13, a base station implementing steps of the method of flowchart 300 of FIG. 3 and/or a base station implementing steps of the method of flowchart 300 of FIG. 3. Exemplary base station 1400 includes a processor 1402, e.g., a CPU, wireless interface 1404, a network interface 1406, an assembly of hardware components 1408, e.g., an assembly of circuits, and memory 1410 coupled together via a bus 1411 over which the various elements may interchange data and information.

Wireless interface 1404 includes a wireless receiver 1412 coupled to one or more receive antennas or receive antenna elements (1420, . . . , 1422), via which the base station 1400 may receive wireless signals, e.g., from end user devices which are cellular capable, e.g. cellphones. Wireless interface 1404 further includes a wireless transmitter 1414 coupled to one or more transmit antennas or transmit antenna elements (1424, . . . , 1426), via which the base station 1400 may transmit wireless signals, e.g., to end user devices which are cellular capable, e.g. cellphones. In some embodiments, the wireless receiver 1412 and wireless transmitter 1414 are included as part of a wireless transceiver 1405.

Network interface 1406, e.g., a wired or optical interface, includes a receiver 1416, a transmitter 1418 and connector 1419. Network interface 1406 couples the base station 1400 to a gateway/router device, e.g., a residential gateway (RG) and/or to the Internet. Memory 1410 includes control routine 1428, an assembly of components 1430, e.g., an assembly of software components, and data/information 1432. Control routine 1428 includes instructions which when executed by processor 1402 control the base station 1400 to implement basic operational functions, e.g., read memory, write to memory, control an interface, load a program, subroutine, or app, etc. Assembly of components 1430, e.g., an assembly of software components, e.g., routines, subroutines, applications, etc., includes, e.g., code, e.g., machine executable instructions, which when executed by processor 1402, controls the base station 1400 to implement steps of a method, e.g., steps of the method of flowchart 200 of FIG. 2 and/or steps of the method of flowchart 300 of FIG. 3. Data/information 1432 includes UE information table 1434, which is e.g., UE information table 500 of Figure S.

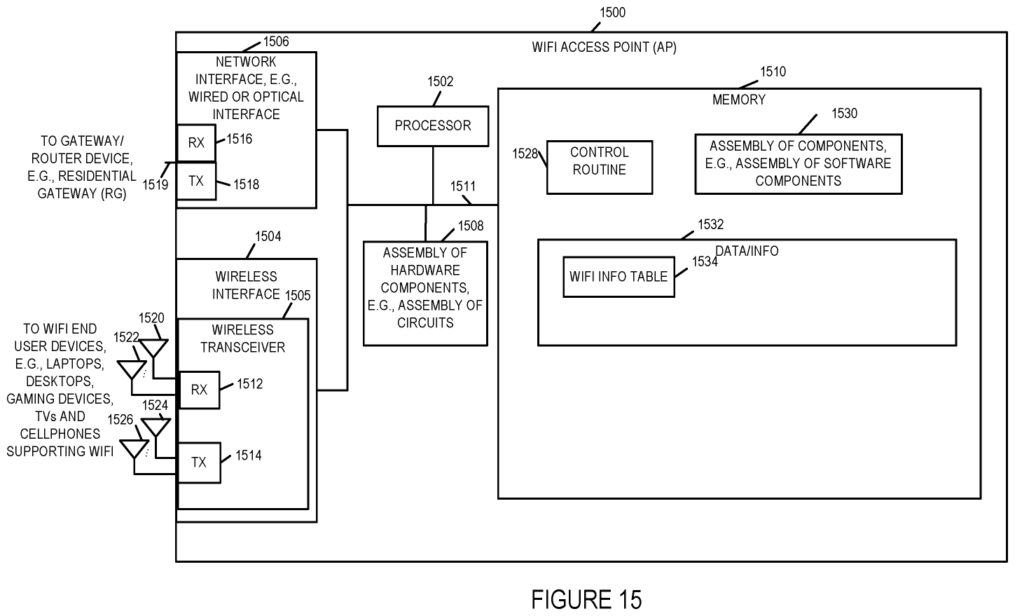

FIG. 15 is a drawing of an exemplary WiFi access point (AP) 1500, in accordance with an exemplary embodiment. Exemplary WiFi AP 1500 is, e.g. any of WiFi AP 140 of system 100 of FIG. 1, WiAP 1434 of gateway/router 1300 of FIG. 13, and/or a WiFi AP implementing steps of the flowchart 200 of FIG. 2 and/or a WiFi AP implementing steps of flowchart 300 of FIG. 3. Exemplary WiFi AP 1500 includes a processor 1502, e.g., a CPU, wireless interface 1504, a network interface 1506, an assembly of hardware components 1508, e.g., an assembly of circuits, and memory 1510 coupled together via a bus 1511 over which the various elements may interchange data and information. Wireless interface 1504 includes a wireless receiver 1512 coupled to one or more receive antennas or receive antenna elements (1520, . . . , 1522), via which the WiFi AP 1500 may receive WiFi wireless signals, e.g., from end user devices which are WiFi capable, e.g. cellphones supporting WiFi communications and other devices, e.g., laptops, desktop PCS, TVs, gaming devices, etc. supporting WiFi communications. Wireless interface 1504 further includes a wireless transmitter 1514 coupled to one or more transmit antennas or transmit antenna elements (1524, . . . , 1526), via which the WiFi AP 1500 may transmit WiFI wireless signals, e.g., to end user devices which are WiFi capable, e.g. cellphones supporting WiFi communications and other devices, e.g., laptops, desktop PCS, TVs, gaming devices, etc. supporting WiFi communications. In some embodiments, the wireless receiver 1512 and wireless transmitter 1514 are included as part of a wireless transceiver 1505.

Network interface 1506, e.g., a wired or optical interface, includes a receiver 1516, a transmitter 1518 and connector 1519. Network interface 1506 couples the WiFi AP 1500 to a gateway/router device, e.g., a residential gateway (RG) and/or to the Internet. Memory 1510 includes control routine 1528, an assembly of components 1530, e.g., an assembly of software components, and data/information 1532. Control routine 1528 includes instructions which when executed by processor 1502 control the WiFi AP 1500 to implement basic operational functions, e.g., read memory, write to memory, control an interface, load a program, subroutine, or app, etc. Assembly of components 1530, e.g., an assembly of software components, e.g., routines, subroutines, applications, etc., includes, e.g., code, e.g., machine executable instructions, which when executed by processor 1502, controls the WiFi AP 1500 to implement steps of a method. Data/information 1532 includes WiFi information table 1534, e.g. WiFi information table 400 of FIG. 4.

Various aspects and/or features of some embodiments of the present invention are described below. Methods and apparatus, in accordance with the present invention, implement a method of capturing a reported MAC address of a WiFi device from a cellphone and identifying the service provider of that cellphone. The captured MAC address may be the original (hardware) MAC address of the WiFi device or may be an artificial temporary randomized MAC address of the WiFi device, when MAC randomization is being used. Using a method of the current invention, e.g., implemented in a residential gateway (RG) that includes a WiFi access point and a base station, e.g. a femtocell HgNB base station, it is possible for a service provider, e.g., service provider A, to deploy its own brand of residential gateway (RG), which will allow it to decide whether to route the WiFi traffic, originating from the WiFi of the cellphone which is serviced by service provider B, to the network of service provider B or to allow the use of the network of service provider A, with a lower quality of service, or to charge a fee for the use of resources of the network of service provider A.

Various embodiments, in accordance with the present invention, relate to a residential gateway (RG), which includes a WiFi access point and a femtocell (known in 3GPP as a Home gNB or HgNB) operating in the CBRS band. By means of customized software, in the RG which includes the functionality described with respect to features and/or aspects in accordance with the invention, it will be possible to: a) know the service provider associated with each of the cellphones that are connected to the femtocell; b) keep track of the time at which cellphones camp on the femtocell; and c) know the time that WiFi devices associate with the WiFi access point.

Using correlation of the times of cellphones connecting to the femtocell and the time of WiFi devices associating with the WiFi access point in the RG, it will be possible to infer that a particular WiFi device is part of a cellphone based on the times being close to each other, and the service provider of that phone. Alternatively, a more sophisticated algorithm, such as using artificial intelligence/machine learning (AI/ML) can be, and sometimes is, implemented and used for helping with the correlation of times (cellular connection times correlated to WiFi attachment times).

More specifically, the detailed description and figures are directed to possible implementations of exemplary methods, in accordance with the present invention. An exemplary method, in accordance with the present invention, will now be described. The RG will keep track of information obtained from the WiFi module and the HgNB module. The WiFi module in the RG will report the time of a new association and the corresponding WiFi user equipment MAC. The RG will store such information in a table, which is sometimes referred to as the WiFi Info table. The HgNB module (the femtocell) in the RG will report the time a new UE (represented by the RAN UE NGAP ID) has connected to the NG-RAN and the PLMN selected by the UE for that connection (as obtained from the PLMN field of the Tracking Area Identity Information Element (TAI IE) in the mandatory User Location information IE of the messages below), as extracted from the messages below. The RG will store such information in a table, which is sometimes referred to as the UE Info table. The UE Info table may include:
a) INITIAL UE MESSAGE (registration when UE is turned on in the femtocell area, or registration when UE is already ON but in CM-IDLE in the macro and camps on the femtocell).
b) PATH SWITCH REQUEST (when a UE is handed over from the macro to the femtocell).

A process in the RG will scan the WiFi Info and UE Info tables periodically in order to correlate the time of a WiFi device associating with the WiFi access module of the RG, and the time of a UE connecting to the HgNB module of the RG. When a correlation of the times is detected, a new table is built that contains the detected MAC address of the WiFi module of the
cellphone, and the service provider of the cellphone. The time the correlation was detected could also be, and in some embodiments is, added to this table that is sometimes referred to as the MAC_Cellphone carrier table.

Knowing that a particular WiFi is associated with a cellphone of mobile operator B, it will be possible for the RG of service provider A to: a) provide service to the WiFi device of a MAC in the MAC_Cellphone_carrier table with a lesser QoS than the traffic of subscribers of service provider A, and b) consider WiFi traffic from a device in the MAC_Cellphone_carrier table as “mobile traffic” from operator B that is roaming in the network of service provider A (allowing it therefore to charge a fee for that roaming traffic).

### Numbered List of Exemplary Method Embodiments:

Method Embodiment 1. A communications method, (e.g., of operating a system (100) including a communications device (102) (e.g., gateway such as a residential gateway (RG) or a router), a WiFi access point (AP) (140) and a cellular base station (e.g., HgNB base station) (138), which are co-located at a first customer premises (198)) (e.g., in some embodiments, the communications device (e.g., gateway such as a residential gateway (RG) or router) includes the WiFi access point (AP) and/or the cellular base station (e.g., HgNB base station)), the method comprising: determining (e.g., correlate cellular connection time to WiFi association time) (342), by a communications device (102) (e.g., a gateway such as residential gateways (RG) or a router) located at a first customer premises (198), if there is a detected WiFi association time corresponding to a first detected cellular connection time (Cellular CT1); and in response to determining that (348) there is a detected WiFi association time (e.g., first detected WiFi association time (WiFi AT1)) corresponding the first detected cellular connection time (Cellular CT1), identifying (352), by the communications device, the WiFi capable end user device (e.g. first WiFi capable end user device) associated with the detected WiFi association time corresponding to the first detected cellular connection time as being the same end user device as a first cellular capable end user device (e.g., based on time of connection of the first cellular capable end user device being within seconds, e.g., a few seconds (under 10, 20 or 60 seconds, depending on the embodiment) of a detected WiFi association time, the device to which the matching WiFi association time corresponds is presumed to be the same device, e.g., UE such as a cellphone supporting cellular and WiFi communications).
Method Embodiment 1A. The method of Method Embodiment 1, further comprising, prior to said step of determining if there is a detected WiFi association time corresponding to a first detected cellular connection time, performing the steps of: detecting (316), at a base station (e.g., HgNB) (138) located at the first customer premises, a new connection with the first cellular capable end user device (116, 118, 120 or 122), said new connection being said first detected cellular connection; determining (318), at the base station, a time of connection (Cellular CT1) of the first cellular capable end user device, said determined time of connection being said first detected cellular connection time; detecting (304), at a WiFi access point (140) at the first customer premises, a new association with a first WiFi capable end user device (116, 118, 120, 122, 124, 126, 128 or 130); and determining (306), at the WiFi access point, a time of WiFi association (WiFi AT1) of the first WiFi capable end user device, said determined time of WiFi association being said first detected WiFi association time
Method Embodiment 1AA. The method of Method Embodiment 1A, further comprising:
storing (310) (e.g., by the WiFi AP or by the communications device) information (e.g., a MAC ID) identifying the first WiFi capable end user device and said first detected WiFi association time (e.g., WiFi AT1).
Method Embodiment 1AA1. The method of Method Embodiment 1AA, further comprising: storing (322) (e.g., by the cellular base station or by the communications device) information (e.g., a UE ID) identifying the first cellular capable end user device and said first detected cellular connection time (e.g., cellular CT1)
Method Embodiment 1AB. The method of Method Embodiment 1AA, wherein determining (e.g., correlate cellular connection time to WiFi association time) (342) if there is a detected WiFi association time corresponding to the first detected cellular connection time includes checking (344) stored information indicating WiFi association times corresponding to one or more WiFi capable end user devices to determine if the first detected cellular connection time (e.g., cellular CT1) is within a predetermined amount of time (e.g., within 60 seconds, 30 seconds, or 10 seconds depending on the embodiment) of one of the detected WiFi association times included in the stored information.
Method Embodiment 1AB1. The method of Method Embodiment 1AB, wherein said predetermined amount of time was determined using at least one of: artificial intelligence (AI) or machine learning (ML). (For example, AI and ML is used on a wide set of data corresponding to multiple different types of cellphones and/or multiple different service providers, to determine one or more predetermined amounts of time, which are to be used as criteria (e.g. a time window).
Method Embodiment 1AB2. The method of Method Embodiment 1AB, wherein said predetermined amount of time is a selected one of a plurality of different alternative predetermined amounts of time, different predetermined amounts of time corresponding to different communications service providers.
Method Embodiment 1AB3. The method of Method Embodiment 1A, wherein said predetermined amount of time is a selected one of a plurality of different alternative predetermined amounts of time, different predetermined amounts of time corresponding to different types of cellphones (e.g., cellphone type information including: iPhone or Android, phone manufacturer, version of cellphone, software version on cellphone).
Method Embodiment 1AC. The method of Method Embodiment IA, wherein said first cellular capable end user device and said first WiFi capable end user device are same end user device, which is a cell phone including a WiFi interface and a cellular interface.
Method Embodiment 1C. The method of Method Embodiment 1A, wherein said communications device is a gateway.
Method Embodiment 1C1. The method of Method Embodiment 1A, wherein said communications device is a router.
Method Embodiment 1C2. The method of Method Embodiment 1C, wherein said communications device is residential gateway (RG).
Method Embodiment 1C3. The method of Method Embodiment 1C2, wherein said WiFi access point and said base station are part of said residential gateway (RG) located at the first customer premises.
Method Embodiment 1C4. The method of Method Embodiment 1C2, wherein said WiFi access point is part of said residential gateway (RG) located at the first customer premises and wherein said base station located at said first customer premises is coupled to said RG.
Method Embodiment 1C5. The method of Method Embodiment 1A, wherein said base station is part of said residential gateway (RG) located at the first customer premises and wherein said WiFi access point located at said first customer premises is coupled to said RG.
Method Embodiment 1C6. The method of Method Embodiment 1A, wherein said RG, said base station and said WiFi access point (AP), are each separate devices, wherein said base station is coupled to said RG, and wherein said WiFi AP is coupled to said AP.
Method Embodiment 1D. The method of Method Embodiment 1C2, wherein said residential gateway (e.g., including a cable modem (CM)) is coupled (via a cable network, e.g., including a CMTS (136), and a W-AGF (139)) to a first core network (106) and to the Internet.
Method Embodiment 1D1. The method of Method Embodiment 1C2, wherein said residential gateway (e.g., including an additional 3GPP wireless interface) is coupled to a first core network (106) via a macro cell base station.
Method Embodiment 1E. The method of Method Embodiment 1A, wherein said base station is a femtocell base station.
Method Embodiment 1F. The method of Method Embodiment 1A, wherein said base station is a Citizens Broadband Radio Services (CBRS) base station.
Method Embodiment 2. The method of Method Embodiment 1A, further comprising: identifying (324 and/or 354) (e.g., by the communications device) a first communications service provider used for the new connection with the first cellular capable end user device (e.g., obtain the PLMN used for that connection).
Method Embodiment 2A. The method of Method Embodiment 2, wherein identifying (324) the first communications service provider used for the new connection with the first cellular capable end user device includes: retrieving (330) a value of a selectedPLMN_Identity field of a RRCSetupCompleteMessage sent to the first cellular capable end user device as part of establishing the new connection with the first cellular capable end user device; and using (332) the retrieved value and a table mapping values to PLMNs to determine the PLMN (where the value is a pointer to a PLMN listed within SIB1, and each PLMN corresponds to a communications service provider sometimes referred to as a Carrier).
Method Embodiment 2B. The method of Method Embodiment 2, wherein identifying (324 and/or 354) a first cellular communications service provider used for the new connection with a first cellular capable end user device includes obtaining (334) a PLMN from the user location information field of a path switch request.
Method Embodiment 3. The method of Method Embodiment 2, further comprising determining (356) (e.g., by the communications device) if the first communications service provider corresponds to a customer premises communications service provider (e.g., service provider A) which provides communications service to the first customer premises; and controlling (366) (e.g., by the communications device) communications service provided to first WiFi capable communications device via WiFi based on whether: i) it is determined that the first communications service provider matches the customer premises communication service provider or ii) it is determined that the first communications service provider does not match the customer premises communication service provider.
Method Embodiment 4. The method of Method Embodiment 3, wherein determining (356) if the first communications service provider corresponds the customer premises communications service provider includes determining (362) that the first communications service provider does not match the customer premises communication service provider; and wherein controlling (366) communications service provided to the first WiFi capable end user device includes (370): i) providing a lower bandwidth to the first WiFi capable end user device than to WIFI capable end user devices determined to correspond to the customer premises communications service provider or ii) providing communications service to the first WiFi capable end user device in accordance with a service agreement, e.g., a WiFi service agreement, with the first communications service provider (e.g., a service agreement between the first communications service provider and the first customer premises communication service provider relating to providing of WiFi services to WiFi capable devices corresponding to the first communications service provider via Wifi access points operated, controlled or associated with the first customer premises communication service provider. In some cases the service agreement, e.g., WiFi service agreement, between the service providers provides for routing communications, e.g., WiFi related communications, via the first communications service provider's core or via the first customer premises communications service provider's core but with the first communications service provider, in some embodiments, being billed, for the communicated information corresponding to a visiting device, (e.g., first communications service provider WiFi capable end user device) passing through the first customer premises' access point).
Method Embodiment 4AA. The method of Method Embodiment 4, wherein controlling (366) communications service provided to the first WiFi capable end user device is an accordance with a service agreement (e.g., a WiFi service agreement) between the first communications service provider (e.g., MNO) and customer premises communications service provider (e.g., MVNO) relating to WiFi traffic communicated via WiFi access points corresponding to the customer premises communications service provider (e.g., access points included in residential gateways of a cable network operator).
Method Embodiment 4A. The method of Method Embodiment 4, wherein controlling (366) communications service provided to the first WiFi capable end user device includes providing (376) a lower bandwidth to the first WiFi capable end user device than to WiFi end user devices corresponding to the first customer premises service communication provider when the first communications service provider does not have a WiFi service agreement with the first customer premises communications service provider
Method Embodiment 4B. The method of Method Embodiment 4, wherein controlling (366) communications service provided to the first WiFi capable end user device includes providing (378) communications service in accordance with a service agreement, e.g., WiFi service agreement, with the first communications service provider, said WiFi service agreement providing (380) an amount of bandwidth which is different than an amount of bandwidth provided to a first customer premises WiFi end user device based on a user agreement corresponding to the first customer premises (e.g., provide a device corresponding to a visitor a higher level of bandwidth than is normally provided to devices at the customer premises which correspond to the customer premises service provider (e.g. WiFi devices at the customer premise corresponding to the customer premises owner are entitled to receive a first amount of bandwidth based on a service agreement, e.g., a WiFi service agreement, with the customer premises communications service provider and the first WiFi capable device visiting the customer premises is entitled to receive a second amount of bandwidth which is greater than the first amount of bandwidth based on a service subscription between the first WiFi capable communications device and the first communications service provider. In such a case the customer premises communications service provider honors the higher amount of bandwidth entitlement because of an agreement, e.g., a WiFi service agreement, between the customer premises communications service provider and the first communications service provider. Thus, in some cases a visitor can get better service than the service which the customer premise resident receives because of the visitor's service contract with the first customer premise service provider.)
Method Embodiment 5, The method of Method Embodiment 3, wherein determining (356) if the first communications service provider corresponds the customer premises communications service provider which provides communications service to the first customer premises includes determining (360) that the first communications provider matches the customer premises communication service provider; and wherein controlling (366) communications service provided to the first WiFi capable end user device includes providing (372) communications bandwidth to the first WiFi capable end user device at a rate provided to WiFi devices corresponding to said first customer premises (e.g. support a bandwidth to the first WiFi capable end user device which matches the bandwidth to which the customer premises is subscribed based on a service agreement, e.g. a WiFi service agreement, with the customer premises service provider and route communications via the customer premises service provider core).
Method Embodiment 6. The method of Method Embodiment 2, further comprising: detecting (304 second iteration), at the WiFi access point at the first customer premises, a new association with a second WiFi capable end user device (e.g., 124, 126, 128, or 130); determining (306 second iteration), at the WiFi access point, a time of WiFi association (WiFi AT2) of the second WiFi capable end user device, said determined time of WiFi association being a second WiFi association time; determining (384) (e.g., correlate cellular connection time to WiFi association time) (234), by the communications device, if there is a detected cellular connection time corresponding to the second WiFi association time; and in response to determining (392) that there is not a cellular connection time corresponding to the second WiFi association time, providing (394), by the communications device, communications service to the second WiFi capable end user device (e.g., 124, 126, 128, or 130) via the customer premises communications service provider.
Method Embodiment 7. The method of Method Embodiment 6, wherein providing (394) communications service to the second WiFi capable end user device via the customer premises communications service provider includes providing (396) bandwidth to the second WiFi capable end user device at a data rate specified by a customer premises agreement corresponding to the first customer premises (and via the customer premises communications service provider's network core).
Method Embodiment 8. The method of Method Embodiment 7, wherein the customer premises communications service provider is an MVNO operator and wherein said first communications service provider is a cellular mobile network operator (MNO) which has a service agreement (e.g., a WiFi service agreement) with the customer premises service provider network operator.

### Numbered List of Exemplary System Embodiments:

System Embodiment 1. A communications system (100), the system comprising: a communications device (102 or 1300) (e.g., a gateway such as a residential gateway (RG) or a router) located at a first customer premises (198), said communication device (102) including a first processor (1302) configured to operate the communications device (102) to: determine (e.g., correlate cellular connection time to WiFi association time) (342), by the communications device (102), if there is a detected WiFi association time corresponding to a first detected cellular connection time (Cellular CT1); and in response to determining that (348) there is a detected WiFi association time (e.g., first detected WiFi association time (WiFi AT1)) corresponding the first detected cellular connection time (Cellular CT1), identify (352), by the communications device (102), the WiFi capable end user device (e.g. first WiFi capable end user device) associated with the detected WiFi association time corresponding to the first detected cellular connection time as being the same end user device as a first cellular capable end user device (e.g., based on time of connection of the first cellular capable end user device being within seconds, e.g., a few seconds (under 10, 20 or 60 seconds, depending on the embodiment) of a detected WiFi association time, the device to which the matching WiFi association time corresponds is presumed to be the same device, e.g., UE such as a cellphone supporting cellular and WiFi communications).
System Embodiment 1A. The communications system of System Embodiment 1, further comprising: a base station (e.g., a HgNB cellular base station) (138 or 1400) located at the first customer premises (198), said base station including a second processor (1402); a WiFi access point (AP) (140 or 1500) located at the first customer premises, said WiFi access point including a third processor (1502); and wherein said second processor is configured to operate the base station to: detect (316), at the base station (e.g., HgNB) located at the first customer premises, a new connection with the first cellular capable end user device (116, 118, 120 or 122), said new connection being said first detected cellular connection; and determine (318), at the base station, a time of connection (Cellular CT1) of the first cellular capable end user device, said determined time of connection being said first detected cellular connection time; and wherein said third processor is configured to operate the WiFi access point to: detect (304), at a WiFi access point at the first customer premises, a new association with a first WiFi capable end user device (116, 118, 120, 122, 124, 126, 128 or 130); and determine (306), at the WiFi access point, a time of WiFi association (WIFI AT1) of the first WiFi capable end user device, said determined time of WiFi association being said first detected WiFi association time. (Steps 316, 318, 304 and 306 being performed prior to steps 34 and 348).
System Embodiment 1AA. The communications system of System Embodiment 1A, wherein said third processor is further configured to operate the WiFi AP to: store (310) (e.g., by the WiFi AP or by the communications device) information (e.g., a MAC ID) identifying the first WiFi capable end user device and said first detected WiFi association time (e.g., WiFi AT1).
System Embodiment 1AA1. The communications device of System Embodiment IAA, wherein said second processor is further configured to operate the base station to: store (322) (e.g., by the cellular base station or by the communications device) information (e.g., a UE ID) identifying the first cellular capable end user device and said first detected cellular connection time (e.g., cellular CT1).
System Embodiment 1AB. The communications system of System Embodiment 1AA, wherein said first processor is configured to operate the communications device to: check (344) stored information indicating WiFi association times corresponding to one or more WiFi capable end user devices to determine if the first detected cellular connection time (e.g., cellular CT1) is within a predetermined amount of time (e.g., within 60 seconds, 30 seconds, or 10 seconds depending on the embodiment) of one of the detected WiFi association times included in the stored information, as part of being configured to operate the communications device to determine (e.g., correlate cellular connection time to WiFi association time) (342) if there is a detected WiFi association time corresponding to the first detected cellular connection time.
System Embodiment 1AB1. The communications system of System Embodiment 1AB, wherein said predetermined amount of time was determined using at least one of: artificial intelligence (AI) or machine learning (ML). (For example, Al and ML is used on a wide set of data corresponding to multiple different types of cellphones and/or multiple different service providers, to determine one or more predetermined amounts of time, which are to be used as criteria (e.g. a time window).
System Embodiment 1AB2. The communications system of System Embodiment 1AB, wherein said predetermined amount of time is a selected one of a plurality of different alternative predetermined amounts of time, different predetermined amounts of time corresponding to different communications service providers.
System Embodiment 1AB3. The communications system of System Embodiment 1A, wherein said predetermined amount of time is a selected one of a plurality of different alternative predetermined amounts of time, different predetermined amounts of time corresponding to different types of cellphones (e.g., cellphone type information including: iPhone or Android, phone manufacturer, version of cellphone, software version on cellphone).
System Embodiment 1AC. The communications system of System Embodiment 1A, wherein said first cellular capable end user device and said first WiFi capable end user device are same end user device (116, 118, 120 or 122), which is a cell phone including a WiFi interface and a cellular interface.
System Embodiment 1C. The communications system of System Embodiment 1A, wherein said communications device is a gateway.
System Embodiment 1C1. The communications system of System Embodiment 1A, wherein said communications device is a router.
System Embodiment 1C2. The communications system of System Embodiment 1C, wherein said communications device is residential gateway (RG) (e.g., a SG-RG)
System Embodiment 1C3. The communications system of System Embodiment 1C2, wherein said WiFi access point and said base station are part of said residential gateway (RG) located at the first customer premises.
System Embodiment 1C4. The communications system of System Embodiment 1C2, wherein said WiFi access point is part of said residential gateway (RG) located at the first customer premises and wherein said base station located at said first customer premises is coupled to said RG.
System Embodiment 1C5. The communications system of System Embodiment 1A, wherein said base station is part of said residential gateway (RG) located at the first customer premises and wherein said WiFi access point located at said first customer premises is coupled to said RG.
System Embodiment 1C6. The communications system of System Embodiment 1A, wherein said RG, said base station and said WiFi access point (AP), are each separate devices, wherein said base station is coupled to said RG, and wherein said WiFi AP is coupled to said AP.
System Embodiment 1D. The communications system of System Embodiment 1C2, wherein said residential gateway (e.g., including a cable modem (CM) (148)) is coupled (via a cable network, e.g., including a CMTS (136), and a W-AGF (139)) to a first core network (106) and to the Internet.
System Embodiment 1D1. The communications system of System Embodiment 1C2, wherein said residential gateway includes an additional 3GPP wireless interface (1360), which coupled the residential gateway (102) to a first core network (106) via a macro cell base station (114).
System Embodiment 1E. The communications system of System Embodiment 1A, wherein said base station is a femtocell base station.
System Embodiment 1F. The communications system of System Embodiment 1A, wherein said base station is a Citizens Broadband Radio Services (CBRS) base station.
System Embodiment 2. The communications system of System Embodiment 1A, wherein said first processor is further configured to operate the communications device to: identify (354) (e.g., by the communications device) a first communications service provider used for the new connection with the first cellular capable end user device (e.g., obtain the PLMN used for that connection).
System Embodiment 2A1. The communications system of System Embodiment 1A, wherein said second processor is further configured to operate the base station to: identify (324) (e.g., by the base station) a first communications service provider used for the new connection with the first cellular capable end user device (e.g., obtain the PLMN used for that connection).
System Embodiment 2A2. The communications system of System Embodiment 2A1, wherein said second processor is configured to operate the base station to: retrieve (330) a value of a selectedPLMN_Identity field of a RRCSetupCompleteMessage sent to the first cellular capable end user device as part of establishing the new connection with the first cellular capable end user device; and use (332) the retrieved value and a table mapping values to PLMNs to determine the PLMN (where the value is a pointer to a PLMN listed within SIB1, and each PLMN corresponds to a communications service provider sometimes referred to as a Carrier), as part of being configured to operate the base station to identify (324) the first communications service provider used for the new connection with the first cellular capable end user device.
System Embodiment 2B. The communications device of System Embodiment 2, wherein said first processor is configured to operate the communications device to: obtain (334) a PLMN from the user location information field of a path switch request, as part of being configured to operate the communications device to identify (354) a first cellular communications service provider used for the new connection with a first cellular capable end user device.
System Embodiment 2B1. The communications device of System Embodiment 2A1, wherein said second processor is configured to operate the base station to: obtain (334) a PLMN from the user location information field of a path switch request, as part of being configured to operate the base station to identify (324) a first cellular communications service provider used for the new connection with a first cellular capable end user device.
System Embodiment 3. The communications system of System Embodiment 2, wherein said first processor is further configured to operate the communications device to: determine (356) (e.g., by the communications device) if the first communications service provider corresponds to a customer premises communications service provider (e.g., service provider A) which provides communications service to the first customer premises; and control (366) (e.g., by the communications device) communications service provided to first WiFi capable communications device via WiFi based on whether: i) it is determined that the first communications service provider matches the customer premises communication service provider or ii) it is determined that the first communications service provider does not match the customer premises communication service provider.
System Embodiment 4. The communications system of System Embodiment 3, wherein said first processor is configured to operate the communications device to: determine (362) that the first communications provider does not match the customer premises communication service provider, as part of being configured to operate the communications device to determine (356) if the first communications service provider corresponds the customer premises communications service provider; and i) provide a lower bandwidth to the first WiFi capable end user device than to WiFI capable end user devices determined to correspond to the customer premises communications service provider or ii) provide communications service to the first WiFi capable end user device in accordance with a service agreement with the first communications service provider (e.g., a WiFi service agreement between the first communications service provider and the first customer premises communication service provider relating to providing of WiFi services to WiFi capable devices corresponding to the first communications service provider via Wifi access points operated, controlled or associated with the first customer premises communication service provider. In some cases the WiFi service agreement between the service providers provides for routing communications communicated via a WiFi access point via the first communications service providers core or via the first customer premises communications service provider's core but with the first communications service provider, in some embodiments, being billed, for the communicated information corresponding to a visiting device, (e.g., first communications service provider WiFi capable end user device) passing through the first customer premises' access point), as part of being configured to operate the communications device to control (366) communications service provided to the first WiFi capable end user device (370).
System Embodiment 4AA. The communications system of System Embodiment 4, wherein controlling (366) communications service provided to the first WiFi capable end user device is an accordance with a service agreement (e.g., a WiFi service agreement) between the first communications service provider (e.g., MNO) and customer premises communications service provider (e.g., MVNO) relating to WiFi traffic communicated via WiFi access points corresponding to the customer premises communications service provider (e.g., access points included in residential gateways of a cable network operator).
System Embodiment 4A. The communications system of System Embodiment 4, wherein said first processor is configured to operate the communications device to: provide (376) a lower bandwidth to the first WiFi capable end user device than to WiFi end user devices corresponding to the first customer premises service communication provider when the first communications service provider does not have a WiFi service agreement with the first customer premises communications service provider, as part of being configured to operate the communications device to control (366) communications service provided to the first WiFi capable end user device.
System Embodiment 4B. The communications system of System Embodiment 4, wherein said first processor is configured to operate the communications device to: provide (378) communications service in accordance with a service agreement (e.g., WiFi service agreement) with the first communications service provider, said service agreement providing (380) an amount of bandwidth which is different than an amount of bandwidth provided to a first customer premises WiFi end user device based on a user agreement corresponding to the first customer premises (e.g., provide a device corresponding to a visitor a higher level of bandwidth than is normally provided to devices at the customer premises which correspond to the customer premises service provider (e.g. WiFi devices at the customer premise corresponding to the customer premises owner are entitled to receive a first amount of bandwidth based on a service agreement with the customer premises communications service provider and the first WiFi capable device visiting the customer premises is entitled to receive a second amount of bandwidth which is greater than the first amount of bandwidth based on a service subscription between the first WiFi capable communications device and the first communications service provider. In such a case the customer premises communications service provider honors the higher amount of bandwidth entitlement because of an agreement, e.g., a WiFi service agreement, between the customer premises communications service provider and the first communications service provider. Thus, in some cases a visitor can get better service than the service which the customer premise resident receives because of the visitor's service contract with the first customer premise service provider), as part of being configured to operate the communication device to control (366) communications service provided to the first WiFi capable end user device.
System Embodiment 5. The communications system of System Embodiment 3, wherein said first processor is configured to operate the communications device to: determine (360) that the first communications provider matches the customer premises communication service provider, as part of being configured to operate the communications device to determine (356) if the first communications service provider corresponds the customer premises communications service provider which provides communications service to the first customer premises, and provide (372) communications bandwidth to the first WiFi capable end user device at a rate provided to WiFi devices corresponding to said first customer premises (e.g. support a bandwidth to the first WiFi capable end user device which matches the bandwidth to which the customer premises is subscribed based on a service agreement with the customer premises service provider and route communications via the customer premises service provider core), as part of being configured to operate the communications device to control (366) communications service provided to the first WiFi capable end user device.
System Embodiment 6. The communications system of System Embodiment 2, wherein said third processor is further configured to operate the WiFi access point to: detect (304 second iteration), at the WiFi access point at the first customer premises, a new association with a second WiFi capable end user device; determine (306 second iteration), at the WiFi access point, a time of WiFi association (WiFi AT2) of the second WiFi capable end user device, said determined time of WiFi association being a second WiFi association time; and wherein said first processor is further configured to operate the communications device to: determine (384) (e.g., correlate cellular connection time to WiFi association time) (234), by the communications device, if there is a detected cellular connection time corresponding to the second WiFi association time; and in response to determining (392) that there is not a cellular connection time corresponding to the second WiFi association time, provide (394), by the communications device, communications service to the second WiFi capable end user device via the customer premises communications service provider.
System Embodiment 7. The communications system of System Embodiment 6, wherein said first processor is configured to operate the communications device to provide (396) bandwidth to the second WiFi capable end user device at a data rate specified by a customer premises agreement corresponding to the first customer premises (and via the customer premises communications service provider's network core), as part of being configured to operate the communications device to provide (394) communications service to the second WiFi capable end user device via the customer premises communications service provider.
System Embodiment 8. The communications system of System Embodiment 7, wherein the customer premises communications service provider (e.g., service provider A) is an MVNO operator and wherein said first communications service provider (e.g., service provider B) is a cellular mobile network operator (MNO) which has a service agreement (e.g., a WiFi service agreement) with the customer premises service provider network operator.

The techniques of various embodiments may be implemented using software, hardware and/or a combination of software and hardware. Various embodiments are directed to apparatus, e.g., end user devices supporting cellular and WiF communications, end user devices supporting WiFi communications, user equipment (UE) devices, communications devices such as gateways, e.g., RGs, SG-RGs, routers, e.g., home routers, W-AGFs, core network devices (e.g., AMF devices, PCF devices, SMF devices, UPF devices, UDM devices, UDR devices etc.), access network devices (e.g., base stations, e.g., HgNB femtocell CBRS base stations, gNBs, WiFi access nodes, e.g., WiFi APs, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to methods, e.g., method of controlling and/or operating communications devices such as gateways, e.g. RGs, e.g., 5G-RG devices, routers such as home routers, W-AGF devices, end user devices such as end user devices supporting both cellular and WiFi communications and end user devices supporting WiFi communications, user equipment (UE) devices, core network devices (e.g., AMF devices, PCF devices, SMF devices, UPF devices, UDM devices, UDR devices, etc.), wireless devices, mobile devices, smartphones, subscriber devices, desktop computers, printers, IPTV, laptops, tablets, network edge devices, base stations, e.g., HgNB femtocell CBRS base stations, Access Points, e.g., WiFi APs, wireless routers, switches, WLAN controllers, orchestration servers, orchestrators, Gateways, AAA servers, servers, nodes and/or elements. Various embodiments are also directed to a machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order, and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements or steps are implemented using hardware circuitry.

In various embodiments devices, e.g., communications devices such as gateways, e.g. residential gateways (RGs), e.g., 5G-RG devices, routers, e.g., home routers, W-AGF devices, end user devices, e.g., end user devices supporting both cellular and WiFi communications and end user devices supporting WiFi communications, user equipment (UE) devices, core network devices (e.g., PCF devices, AMF devices, SMF devices, UPF devices, UDM devices, UDR devices, etc.), wireless devices, mobile devices, smartphones, subscriber devices, desktop computers, printers, IPTV, laptops, tablets, network edge devices, base stations, e.g., HgNB femtocell CBRS base stations, Access Points, e.g., WiFi APs, wireless routers, switches, WLAN controllers, orchestration servers, orchestrators, Gateways, AAA servers, servers, nodes and/or elements described herein are implemented using one or more components to perform the steps corresponding to one or more methods, for example, provisioning user equipment devices, provisioning AP devices, provisioning AAA servers, provisioning orchestration servers, generating messages, message reception, message transmission, signal processing, sending, comparing, determining and/or transmission steps. Thus, in some embodiments various features are Implemented using components o″ in ‘ome embodiments logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., communications devices such as gateways, e.g., residential gateways (RGs), e.g., 5G-RG devices, routers, e.g., home routers, W-AGF devices, 3GPP access network devices, end user devices, e.g., end user devices supporting both cellular and WiFi communications, user (UE) devices, core network devices (e.g., PCF devices, AMF devices, SMF devices, UPF devices, UDM devices, UDR devices, etc.), wireless devices, mobile devices, smartphones, subscriber devices, desktop computers, printers, IPTV, laptops, tablets, network edge devices, base stations, e.g. HgNB CBRS femetocell base stations, Access Points, e.g., WiFi APs, wireless routers, switches, WLAN controllers, orchestration servers, orchestrators, Gateways, AAA servers, servers, nodes and/or elements, are configured to perform the steps of the methods described as being performed by the user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., communications devices such as gateways, e.g., residential gateways (RGs), e.g., 5G-RG devices, W-AGF devices, end user devices, e.g., end user devices supporting both cellular and WiFi communications and end user devices supporting WiFi communications, a user equipment (UE) devices, core network devices (e.g., PCF devices, AMF devices, SMF devices, UPF devices, UDM devices, UDR devices, etc.), wireless devices, mobile devices, smartphones, subscriber devices, desktop computers, printers, IPTV, laptops, tablets, network edge devices, base stations, e.g. HgNB CBRS femtocell base stations, Access Points, e.g., WiFi APs, wireless routers, switches, WLAN controllers, orchestration servers, orchestrators, Gateways, AAA servers, servers, nodes and/or elements, with a processor which includes a component corresponding to each of the steps of the various described methods performed by the device in which the processor is included. In some but not all embodiments a device, e.g., gateway such as a residential gateway (RG), e.g., a 5G-RG devices, a w-AGF device, an end user device, e.g., an end user device supporting both cellular and WiFi communications or an end user device supporting WiFi communications, a 3GPP access network device, user equipment (UE) device, core network device (e.g., PCF device, AMF device, SMF device, UPF device, EDM device, UDR device, etc.), wireless device, mobile device, smartphone, subscriber device, desktop computer, printer, IPTV, laptop, tablet, network edge device, Access Point, e.g., a WiFi AP, a wireless router, switch, WLAN controller, orchestration server, orchestrator, Gateway, AAA server, server, node and/or element, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., a communications device such as a gateway, e.g., a residential gateway (RG), e.g., 5G-RG devices, W-AGF devices, 3GPP access network devices, end user devices, e.g., end user device supporting cellular and WiFi communications or an end user device supporting WiFi communications, user (UE) devices, core network devices (e.g., PCF devices, AMF devices, SMF devices, UPF devices, UDM devices, UDR devices, etc.), wireless devices, mobile devices, smartphones, subscriber devices, desktop computers, printers, IPTV, laptops, tablets, network edge devices, base stations, e.g. a HgNB CBRS femtocell base station, Access Points, e.g., WiFi APs, wireless routers, switches, WLAN controllers, orchestration servers, orchestrators, Gateways, AAA servers, servers, nodes and/or elements. The code may be in the form of machine, e.g., computer, executable Instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such as a gateway such as a residential gateway (RG), e.g. a 5G-RG device, a router, e.g., a home router, a W-AGF device, a 3GPP access network device, e.g., a gNB, an end user device such as an end user device supporting both cellular and WiFi communications or an end user device supporting WiFi communications, a user equipment (UE) device, core network device (e.g., PCF device, AMF device, SMF device, UPF device, UDM device, UDR device, etc.), wireless device, mobile device, smartphone, subscriber device, desktop computer, printer, IPTV, laptop, tablets, network edge device, a base station, e.g., a HgNB CBRS femtocell base station, and Access Point, e.g., a WiFi AP, wireless router, switch, WLAN controller, orchestration server, orchestrator, Gateway, AAA server, server, node and/or element or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A communications method, the method comprising:
determining, by a communications device located at a first customer premises, if there is a detected WiFi association time corresponding to a first detected cellular connection time; and
in response to determining that there is a detected WiFi association time corresponding the first detected cellular connection time, identifying, by the communications device, the WiFi capable end user device associated with the detected WiFi association time corresponding to the first detected cellular connection time as being the same end user device as a first cellular capable end user device.

2. The method of claim 1, further comprising, prior to said step of determining if there is a detected WiFi association time corresponding to a first detected cellular connection time, performing the steps of:
detecting, at a base station located at the first customer premises, a new connection with the first cellular capable end user device, said new connection being said first detected cellular connection;
determining, at the base station, a time of connection of the first cellular capable end user device, said determined time of connection being said first detected cellular connection time;
detecting, at a WiFi access point at the first customer premises, a new association with a first WiFi capable end user device; and
determining, at the WiFi access point, a time of WiFi association of the first WiFi capable end user device, said determined time of WiFi association being said first detected WiFi association time.

3. The method of claim 2, wherein said first cellular capable end user device and said first WiFi capable end user device are same end user device, which is a cell phone including a WiFi interface and a cellular interface.

4. The method of claim 2, further comprising:
identifying a first communications service provider used for the new connection with the first cellular capable end user device.

5. The method of claim 4, further comprising
determining if the first communications service provider corresponds to a customer premises communications service provider which provides communications service to the first customer premises; and
controlling communications service provided to first WiFi capable communications device via WiFi based on whether: i) it is determined that the first communications service provider matches the customer premises communication service provider or ii) it is determined that the first communications service provider does not match the customer premises communication service provider.

6. The method of claim 5, wherein determining if the first communications service provider corresponds the customer premises communications service provider includes determining that the first communications service provider does not match the customer premises communication service provider; and
wherein controlling communications service provided to the first WiFi capable end user device includes: i) providing a lower bandwidth to the first WiFi capable end user device than to WiFI capable end user devices determined to correspond to the customer premises communications service provider or ii) providing communications service to the first WiFi capable end user device in accordance with a service agreement, e.g., a WiFi service agreement, with the first communications service provider.

7. The method of claim 5,
wherein determining if the first communications service provider corresponds the customer premises communications service provider which provides communications service to the first customer premises includes determining that the first communications provider matches the customer premises communication service provider; and
wherein controlling communications service provided to the first WiFi capable end user device includes providing communications bandwidth to the first WiFi capable end user device at a rate provided to WiFi devices corresponding to said first customer premises.

8. The method of claim 4, further comprising:
detecting, at the WiFi access point at the first customer premises, a new association with a second WiFi capable end user device;
determining, at the WiFi access point, a time of WiFi association of the second WiFi capable end user device, said determined time of WiFi association being a second WiFi association time;
determining, by the communications device, if there is a detected cellular connection time corresponding to the second WiFi association time; and
in response to determining that there is not a cellular connection time corresponding to the second WiFi association time, providing, by the communications device, communications service to the second WiFi capable end user device via the customer premises communications service provider.

9. The method of claim 8, wherein providing communications service to the second WiFi capable end user device via the customer premises communications service provider includes providing bandwidth to the second WiFi capable end user device at a data rate specified by a customer premises agreement corresponding to the first customer premises.

10. The method of claim 9, wherein the customer premises communications service provider is an MVNO operator and wherein said first communications service provider is a cellular mobile network operator (MNO) which has a service agreement with the customer premises service provider network operator.

11. A communications system, the system comprising:
a communications device located at a first customer premises, said communication device including a first processor configured to operate the communications device to:
determine, by the communications device, if there is a detected WiFi association time corresponding to a first detected cellular connection time; and
in response to determining that there is a detected WiFi association time corresponding the first detected cellular connection time, identify, by the communications device, the WiFi capable end user device associated with the detected WiFi association time corresponding to the first detected cellular connection time as being the same end user device as a first cellular capable end user device.

12. The communications system of claim 11, further comprising:
a base station located at the first customer premises, said base station including a second processor;
a WiFi access point located at the first customer premises, said WiFi access point including a third processor; and
wherein said second processor is configured to operate the base station to:
detect, at the base station located at the first customer premises, a new connection with the first cellular capable end user device, said new connection being said first detected cellular connection; and
determine, at the base station, a time of connection of the first cellular capable end user device, said determined time of connection being said first detected cellular connection time; and
wherein said third processor is configured to operate the WiFi access point to:
detect, at a WiFi access point at the first customer premises, a new association with a first WiFi capable end user device; and
determine, at the WiFi access point, a time of WiFi association of the first WiFi capable end user device, said determined time of WiFi association being said first detected WiFi association time.

13. The communications system of claim 12, wherein said first cellular capable end user device and said first WiFi capable end user device are same end user device, which is a cell phone including a WiFi interface and a cellular interface.

14. The communications system of claim 12, wherein said first processor is further configured to operate the communications device to:
identify a first communications service provider used for the new connection with the first cellular capable end user device.

15. The communications system of claim 14, wherein said first processor is further configured to operate the communications device to:
determine if the first communications service provider corresponds to a customer premises communications service provider which provides communications service to the first customer premises; and
control communications service provided to first WiFi capable communications device via WiFi based on whether: i) it is determined that the first communications service provider matches the customer premises communication service provider or ii) it is determined that the first communications service provider does not match the customer premises communication service provider.

16. The communications system of claim 15, wherein said first processor is configured to operate the communications device to:
determine that the first communications provider does not match the customer premises communication service provider, as part of being configured to operate the communications device to determine if the first communications service provider corresponds the customer premises communications service provider; and
i) provide a lower bandwidth to the first WiFi capable end user device than to WiFI capable end user devices determined to correspond to the customer premises communications service provider or ii) provide communications service to the first WiFi capable end user device in accordance with a service agreement with the first communications service provider.

17. The communications system of claim 15, wherein said first processor is configured to operate the communications device to:
determine that the first communications provider matches the customer premises communication service provider, as part of being configured to operate the communications device to determine if the first communications service provider corresponds the customer premises communications service provider which provides communications service to the first customer premises; and
provide communications bandwidth to the first WiFi capable end user device at a rate provided to WiFi devices corresponding to said first customer premises, as part of being configured to operate the communications device to control communications service provided to the first WiFi capable end user device.

18. The communications system of claim 14,
wherein said third processor is further configured to operate the WiFi access point to:
detect, at the WiFi access point at the first customer premises, a new association with a second WiFi capable end user device;
determine, at the WiFi access point, a time of WiFi association of the second WiFi capable end user device, said determined time of WiFi association being a second WiFi association time; and
wherein said first processor is further configured to operate the communications device to:
determine, by the communications device, if there is a detected cellular connection time corresponding to the second WiFi association time; and
in response to determining that there is not a cellular connection time corresponding to the second WiFi association time, provide, by the communications device, communications service to the second WiFi capable end user device via the customer premises communications service provider.

19. The communications system of claim 18, wherein said first processor is configured to operate the communications device to provide bandwidth to the second WiFi capable end user device at a data rate specified by a customer premises agreement corresponding to the first customer premises, as part of being configured to operate the communications device to provide communications service to the second WiFi capable end user device via the customer premises communications service provider.

20. The communications system of claim 19, wherein the customer premises communications service provider is an MVNO operator and wherein said first communications service provider is a cellular mobile network operator (MNO) which has a service agreement with the customer premises service provider network operator.
